(19) United States
(12) Patent Application Publication
(10) Pub. No.: US 2023/0394560 A1
(43) Pub. Date: Dec. 7, 2023

(54) INFORMATION PROCESSING SYSTEM, INFORMATION PROCESSING METHOD, AND PROGRAM

(71) Applicant: GREE, INC., Tokyo (JP)

(72) Inventor: Seiji OCHIAI, Saitama (JP)

(73) Assignee: GREE, INC., Tokyo (JP)

(21) Appl. No.: 18/329,287

(22) Filed: Jun. 5, 2023

(30) Foreign Application Priority Data
Jun. 6, 2022 (JP) 2022-091421

(51) Int. Cl. G06Q 30/0601; G06T 11/00

(52) U.S. Cl. CPC G06Q 30/0641; G06T 11/00

(57) ABSTRACT

An information processing system includes a first state change processor, a history memory, a user information memory, and an association processor. The first state change processor changes an association state of a specific virtual reality medium usable in a virtual space from a state of being associated with a first user to a state of being associated with a second user. The association processor generates or updates predetermined information related to the specific virtual reality medium, based on the user information related to at least one target user among a plurality of target users including (i) a past user associated with the specific virtual reality medium in the association state included in the change history and (ii) the second user associated with the specific virtual reality medium.

This application claims the benefit of priority from Japanese Patent Application No. 2022-091421 filed Jun. 6, 2022, the entire contents of the prior application(s) being incorporated herein by reference.

### TECHNICAL FIELD

This disclosure relates to an information processing system, an information processing method, and a program.

### BACKGROUND TECHNOLOGY

A technology is known that supports the transaction of items between users in a virtual space.

### SUMMARY

### Problems to be Resolved

However, in the above-mentioned conventional technology, information associated with an item to be transacted in the virtual space is insufficient for a user considering a purchase, and it is difficult to promote activation of the transaction.

Therefore, in one aspect, an object of this disclosure is to promote activation of various transactions related to a specific virtual reality medium in a virtual space.

In one aspect, an information processing system is provided that includes:
a first state change processor that changes an association state of a specific virtual reality medium usable in a virtual space from a state of being associated with one user to a state of being associated with another one user;
a history memory that stores a change history of the association state related to the specific virtual reality medium;
a user information memory that stores user information related to a plurality of users; and
an association processor that generates or updates predetermined information related to the specific virtual reality medium, based on the user information related to at least one target user among a plurality of target users including (i) one user among one or more past users associated with the specific virtual reality medium in at least one of the association states included in the change history; and (ii) the other one user associated with the specific virtual reality medium.

### Effects

In one aspect, according to this disclosure, it is possible to promote various transactions related to a specific virtual reality medium in a virtual space.

### BRIEF DESCRIPTION OF DRAWINGS

FIG. 1 is a block diagram of a virtual reality generation system according to this embodiment.

FIG. 2 is an explanatory diagram of a terminal image that can be viewed via a head-mounted display.

FIG. 3 is an explanatory diagram of operation input by a gesture.

FIG. 4 is an image diagram of a flea market in a metaverse space.

FIG. 5 is an image diagram of a flea market in a non-metaverse space.

FIG. 6 is an explanatory diagram of an example of a virtual space that can be generated by a virtual reality generation system.

FIG. 7 is a schematic block diagram showing functions of a server device related to a flea market.

FIG. 8 is an explanatory diagram showing an example of data in an item information memory;

FIG. 9 is an explanatory diagram showing an example of data in a sale information memory.

FIG. 10 is an explanatory diagram showing an example of data in a user information memory.

FIG. 11 is an explanatory diagram of possessed item information.

FIG. 12 is an explanatory diagram showing an example of data in an avatar information memory.

FIG. 13 is a schematic flowchart showing an example of processing for generating or updating item value information.

FIG. 14 is a schematic flowchart showing an example of item value calculation processing (step S1308 in FIG. 13).

FIG. 15 is a schematic flowchart showing an example of item value calculation processing (step S1408 in FIG. 14) based on an individual value.

FIG. 16 is a schematic flowchart showing another example of item value calculation processing (step S1308 in FIG. 13);

FIG. 17 is an explanatory diagram of processing in FIG. 16, and is an explanatory diagram of a method of calculating a correction coefficient.

FIG. 18 is a schematic flowchart showing an example of processing for generating or updating item attribute information;

FIG. 19 is a flowchart showing an example of an operation in a virtual reality generation system.

FIG. 20 is a timing chart schematically showing a flow of processing when a selling-side user exhibits an avatar item at a flea market in a virtual space.

FIG. 21 is an explanatory diagram showing an example of a flea market-related screen on a smartphone or the like.

FIG. 22 is a timing chart schematically showing a flow of processing when a buying user buys an avatar item displayed at a flea market in a virtual space.

### MODES FOR IMPLEMENTING EMBODIMENTS

Hereinafter, each embodiment will be described with reference to the drawings. In the attached drawings, for ease of viewing, only a portion of a plurality of parts having the same attribute may be given reference numerals.

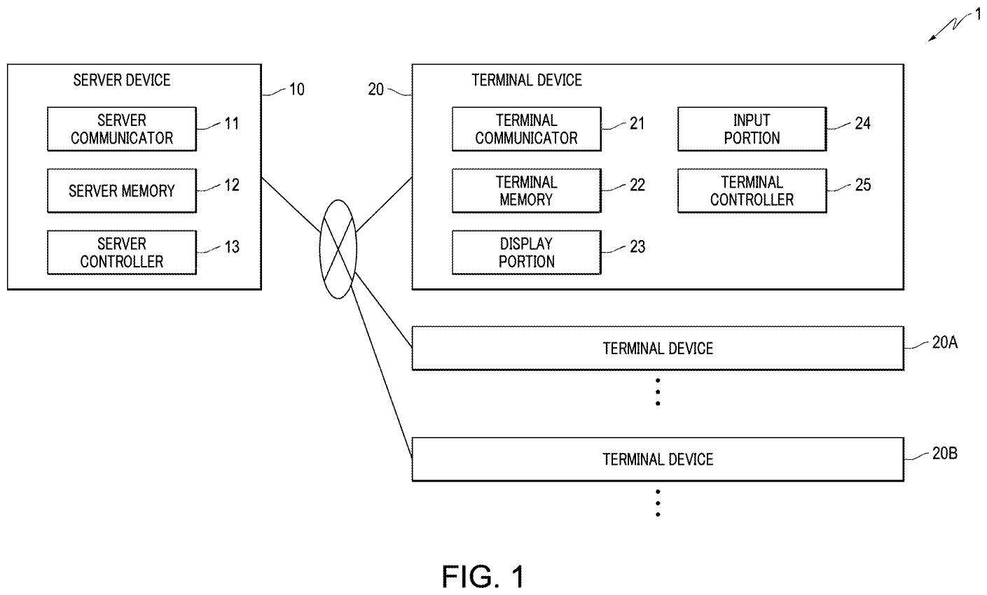

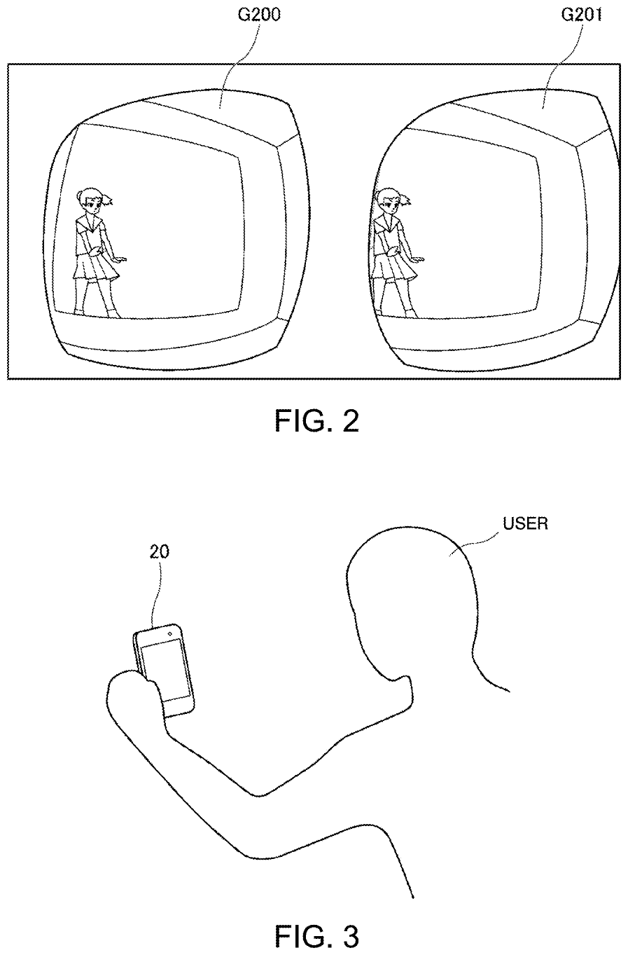

With reference to FIG. 1, an overview of a virtual reality generation system 1 according to an embodiment will be described. FIG. 1 is a block diagram of a virtual reality generation system 1 according to this embodiment. FIG. 2 is an explanatory diagram of a terminal image that can be viewed through a head-mounted display.

The virtual reality generation system 1 includes a server device 10 and one or more terminal devices 20. Although three terminal devices 20, 20A, and 20B are illustrated in FIG. 1 for simplicity, the number of terminal devices 20 may be two or more.

The server device 10 is an information system, for example, a server or the like managed by an administrator who provides one or more virtual realities. The terminal device 20 is a device used by a user, such as a mobile phone, a smartphone, a tablet terminal, a PC (Personal Computer), a head-mounted display, a game device, or the like. The terminal device 20 is typically different for each user. A plurality of terminal devices 20 can be connected to the server device 10 via a network 3.

The terminal device 20 can execute a virtual reality application according to this embodiment. The virtual reality application may be received by the terminal device 20 from the server device 10 or a predetermined application distribution server via the network 3. Alternatively, it may be stored in advance in a memory device provided in the terminal device 20 or in a memory medium such as a memory card that can be read by the terminal device 20. The server device 10 and the terminal device 20 are communicably connected via the network 3. For example, the server device 10 and the terminal device 20 cooperate to perform various processes related to virtual reality.

The terminal devices 20 are communicably connected to each other via the server device Hereinafter, “one terminal device 20 sends information to another terminal device 20” means “one terminal device 20 sends information to another terminal device 20 via the server device 10.” Similarly, “one terminal device 20 receives information from another terminal device 20” means “one terminal device 20 receives information from another terminal device 20 via the server device 10.” However, in a modification, each terminal device 20 may be communicably connected without going through the server device 10.

The network 3 may include a wireless communication network, the Internet, a VPN (Virtual Private Network), a WAN (Wide Area Network), a wired network, or any combination of these, or the like.

Hereinafter, the virtual reality generation system 1 realizes an example of the information processing system, but each element of a specific terminal device 20 (see a terminal communication portion 21 to a terminal controller 25 in FIG. 1) may realize an example of the information processing system. Alternatively, a plurality of terminal devices 20 may work together to realize an example of the information processing system. Additionally, the server device 10 alone may realize an example of the information processing system. Alternatively, the server device 10 and one or more terminal devices 20 may work together to realize an example of an information processing system.

Here, a summary of a virtual reality according to this embodiment will be described. A virtual reality according to this embodiment is, for example, a virtual reality for any reality such as education, travel, role-playing, simulation, entertainment such as games and concerts, or the like. A virtual reality medium such as an avatar is used in execution of the virtual reality. For example, virtual reality according to this embodiment is realized by a three-dimensional virtual space, various virtual reality media that appear in the virtual space, and various contents provided in the virtual space.

Virtual reality media are electronic data used in virtual reality, and include any medium such as cards, items, points, in-service currency (or virtual reality currency), tokens (for example, Non-Fungible Token (NFT)), tickets, characters, avatars, parameters, or the like. Additionally, virtual reality media may be virtual reality-related information such as level information, status information, parameter information (physical strength, offensive ability, or the like) or ability information (skills, abilities, spells, jobs, or the like). Furthermore, the virtual reality media are electronic data that can be acquired, owned, used, managed, exchanged, combined, reinforced, sold, disposed of, or gifted or the like by a user in the virtual reality. However, usage of the virtual reality media is not limited to those specified in this specification.

An avatar is typically in the form of a character with a frontal orientation, and may have a form of a person, an animal, or the like. An avatar can have various appearances (appearances when drawn) by being associated with various avatar items. Additionally, hereinafter, due to the nature of avatars, a user and an avatar may be treated as the same. Therefore, for example, “one avatar does XX” may be synonymous with “one user does XX.”

A user may wear a mounted device on the head or a part of the face and visually recognize a virtual space through the mounted device. The mounted device may be a head-mounted display or a glasses-type device. A glasses-type device may be so-called AR (Augmented Reality) glasses or so-called MR (Mixed Reality) glasses. In any case, the mounted device may be separate from the terminal device 20, or may realize part or all of functions of the terminal device 20. The terminal device 20 may be realized by a head-mounted display.

### (Configuration of Server Device)

A configuration of the server device 10 will be described in detail. The server device 10 is constituted by a server computer. The server device 10 may be realized by a plurality of server computers working together. For example, the server device 10 may be realized by a server computer that provides various contents, a server computer that realizes various authentication servers, and the like. Additionally, the server device 10 may also include a Web server. In this case, some functions of the terminal device 20 described hereafter may be realized by a browser processing HTML documents received from the Web server and various programs (JavaScript) associated with them.

As shown in FIG. 1, the server device 10 includes a server communicator 11, a server memory 12, and a server controller 13.

The server communicator 11 includes an interface that communicates with an external device wirelessly or by wire to send and receive information. The server communicator 11 may include, for example, a wireless LAN (Local Area Network) communication module or a wired LAN communication module or the like. The server communicator 11 can send and receive information to and from the terminal devices 20 via the network 3.

The server memory 12 is, for example, a memory device, and stores various information and programs necessary for various processes related to virtual reality.

The server controller 13 may include a dedicated microprocessor or a CPU (Central Processing Unit) that performs specific functions by loading a specific program, a GPU (Graphics Processing Unit), and the like. For example, the server controller 13 cooperates with the terminal device 20 to execute a virtual reality application in response to user input.

### (Configuration of Terminal Device)

A configuration of the terminal device 20 will be described. As shown in FIG. 1, the terminal device 20 is provided with a terminal communicator 21, a terminal memory 22, a display portion 23, an input portion 24, and a terminal controller 25.

The terminal communicator 21 communicates with an external device wirelessly or by wire, and includes an interface for sending and receiving information. The terminal communicator 21 may include, for example, a wireless communication module, a wireless LAN communication module, or a wired LAN communication module, or the like corresponding to a mobile communication standard such as LTE (Long Term Evolution) (registered trademark), LTE-A (LTE-Advanced), a fifth generation mobile communications system, or UMB (Ultra Mobile Broadband). The terminal communicator 21 can send and receive information to and from the server device 10 via the network 3.

The terminal memory 22 includes, for example, primary and secondary memory devices. For example, the terminal memory 22 may include a semiconductor memory, a magnetic memory, or optical memory, or the like. The terminal memory 22 stores various information and programs used in the processing of virtual reality that are received from the server device 10. The information and programs used in the processing of virtual reality may be acquired from an external device via the terminal communicator 21. For example, a virtual reality application program may be acquired from a predetermined application distribution server. Hereinafter, an application program is also referred to simply as an application.

Additionally, the terminal memory 22 may store data for drawing a virtual space, for example, an image of an indoor space such as a building, an image of an outdoor space, or the like. Also, a plurality of types of data for drawing a virtual space may be prepared for each virtual space and used separately.

Additionally, the terminal memory 22 may store various images (texture images) for projection (texture mapping) onto various objects placed in a three-dimensional virtual space.

For example, the terminal memory 22 stores avatar drawing information related to avatars as virtual reality media associated with each user. An avatar in the virtual space is drawn based on the avatar drawing information related to the avatar.

Also, the terminal memory 22 stores drawing information related to various objects (virtual reality media) different from avatars, for example, various gift objects, buildings, walls, NPCs (Non Player Characters), and the like. Various objects are drawn in the virtual space based on such drawing information. A gift object is an object that corresponds to a gift from one user to another user, and is part of an item. A gift object may be a thing worn by an avatar (clothes or accessories), a decoration (fireworks, flowers, or the like), a background (wallpaper), or the like, or a ticket or the like that can be used for gacha (lottery). The term “gift” used in this application means the same concept as the term “token.” Therefore, it is also possible to replace the term “gift” with the term “token” to understand the technology described in this application.

The display portion 23 includes a display device, for example, a liquid crystal display or an organic EL (Electro-Luminescent) display. The display portion 23 can display various images. The display portion 23 is constituted by, for example, a touch panel, and functions as an interface that detects various user operations. Additionally, as described above, the display portion 23 may be in the form of a head-mounted display.

The input portion 24 may include physical keys or may further include any input interface, including a pointing device such as a mouse or the like. The input portion 24 may also be able to accept non-contact-type user input, such as sound input, gesture input, or line-of-sight input. Gesture input may use sensors (image sensors, acceleration sensors, distance sensors, and the like) to detect various user states, special motion capture that integrates sensor technology and a camera, and a controller such as a joypad. Also, a line-of-sight detection camera may be arranged in a head-mounted display. The user's various states are, for example, the user's orientation, position, movement, or the like. In this case, the orientation, position, and movement of the user include not only the orientation, position, and movement of part or all of the user's body, such as the face and hands, but also the orientation, position, movement, and the like of the user's line of sight.

Operation input by gestures may be used to change a viewpoint of a virtual camera. For example, when a user changes a direction of the terminal device 20 while holding the terminal device 20 with his or her hand as schematically shown in FIG. 3, the viewpoint of the virtual camera may be changed according to the direction. In this case, even when using a terminal device 20 with a relatively small screen such as a smartphone, a wide viewing area can be ensured in the same manner as the surroundings can be looked around via a head-mounted display.

The terminal controller 25 includes one or more processors. The terminal controller 25 controls the overall operation of the terminal device 20.

The terminal controller 25 sends and receives information via the terminal communicator 21. For example, the terminal controller 25 receives various information and programs used for various processes related to virtual reality from at least one of (i) the server device 10 and (ii) another external server. The terminal controller 25 stores the received information and programs in the terminal memory 22. For example, the terminal memory 22 may contain a browser (Internet browser) for connecting to a Web server.

The terminal controller 25 activates a virtual reality application in response to a user operation. The terminal controller 25 cooperates with the server device 10 to execute various processes related to virtual reality. For example, the terminal controller 25 displays an image of the virtual space on the display portion 23. On the screen, for example, a GUI (Graphical User Interface) may be displayed that detects a user operation. The terminal controller 25 can detect a user operation via the input portion 24. For example, the terminal controller 25 can detect various operations by user gestures (operations corresponding to a tap operation, a long tap operation, a flick operation, a swipe operation, and the like). The terminal controller 25 sends the operation information to the server device 10.

The terminal controller 25 draws an avatar or the like together with the virtual space (image), and causes the display portion 23 to display a terminal image. In this case, for example, as shown in FIG. 2, a stereoscopic image for a head-mounted display may be generated by generating images G200 and G201 that can be viewed with the right and left eyes, respectively. FIG. 2 schematically shows the images G200 and G201 that can be viewed by the right and left eyes, respectively. Hereinafter, unless otherwise specified, images in the virtual space refer to the entire images represented by the images G200 and G201. Additionally, the terminal controller 25 realizes various movements of the avatar in the virtual space, for example, according to various operations by a user.

The virtual space described below is an immersive space that can be viewed using a head-mounted display or the like, and is a concept that includes not only a continuous three-dimensional space in which the user can freely (like in real life) move around via an avatar, but also a non-immersive space that can be viewed using a smartphone or the like as described above with reference to FIG. 3. Additionally, a non-immersive space that can be viewed using a smartphone or the like may be a continuous three-dimensional space in which the user can freely move around via an avatar, or a two-dimensional space that may be a discontinuous space. Hereinafter, when distinguishing, a continuous three-dimensional space in which a user can freely move around via an avatar is also referred to as a “metaverse space,” and other virtual spaces (for example, discontinuous spaces) are referred to as a “non-metaverse spaces.”

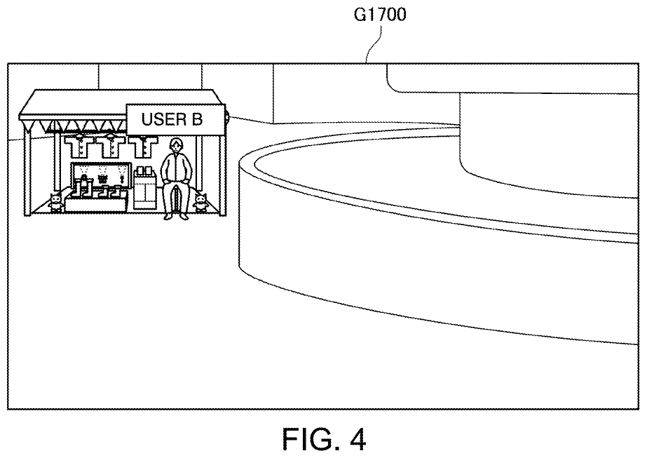

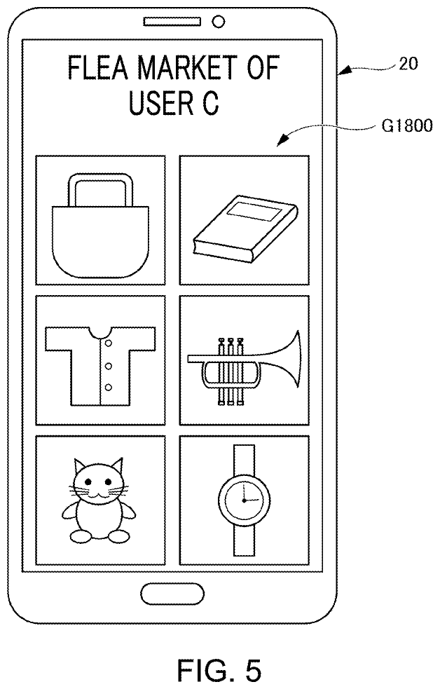

Next, with reference to FIGS. 4 and 5, a flea market in a virtual space will be described.

FIG. 4 is an image diagram of a flea market in a metaverse space, and shows an example of a virtual space image G1700 that can be viewed via the terminal device 20. FIG. 5 is an image diagram of a flea market in a non-metaverse space, and shows an example of a virtual space image G1800 that can be viewed via the terminal device 20.

In this embodiment, each user can change an association state of a specific virtual reality medium (hereinafter also referred to as “specific virtual reality medium”). The specific virtual reality medium can be any virtual reality medium described above, and is not limited to the avatar item(s) described hereinafter, and may include items that can be placed in the virtual space (including, for example, personal property such as a building such as a house or the like in the virtual space, and real estate such as land, as well as furniture and decorations placed in a virtual room of the avatar). However, a specific virtual reality medium is typically a virtual reality medium that can be associated with one or more users, and may exclude virtual reality media related to public property. In this embodiment, for convenience of explanation, it is assumed that a specific virtual reality medium can be associated with one user unless otherwise specified. In this case, disposal of the specific virtual reality medium can basically be decided only by the one associated user. If a specific virtual reality medium can be associated with two or more users, it becomes a “shared item,” and disposal of the specific virtual reality medium may basically be based on an agreement of two or more associated users (agreement of other users). Such legal relationships may be similar to reality (for example, the Japanese Civil Code) or may be amended as needed. In the virtual reality generation system 1 according to this embodiment, there may be one specific virtual reality medium or a plurality of specific virtual reality media, but in the case of a plurality of specific virtual reality media, the plurality of specific virtual reality media are provided so as to be mutually identifiable. The specific virtual reality medium can be arbitrarily selected from the virtual reality media described above, but a non-fungible token (NFT), which is a unique, non-fungible and tradable data unit recorded on a blockchain can be suitably used.

### <Temporary Number>

Here, to explain an NFT, an NFT is (a) digital data such as an image, (b) metadata related to (a), (c) index data related to (b), and (d) data in which part or all of (c) is recorded on a blockchain (tokenized). An NFT has the following features.
Metadata (a) and index data (c) are linked.
“Holding an NFT” physically means that “only the user knows a private key corresponding to an address (wallet) where a token on a certain blockchain is recorded.”
“Assign an NFT” and “receive an NFT” physically mean that “index data related to the NFT is be moved from one address to another.”
An NFT is a unique, non-fungible token that can be distinguished from other tokens.
An NFT can be assigned by smart contract. All transaction histories are published on the blockchain and can be viewed by anyone.

### <Temporary Number >

In the virtual reality generation system 1 according to this embodiment, an NFT may be used as follows.
Each user issues a specific virtual reality medium as an NFT.
The NFT is recorded on a blockchain outside the virtual reality generation system 1.
NFTs are traded with other users using existing crypto assets on the blockchain.

An association state of the specific virtual reality medium shows an association state of each user with the specific virtual reality medium. A change in the association state of the specific virtual reality medium means a change from the association state associated with one user to the association state associated with another user. Here, the association state is a concept including (i) a state in which each user owns a specific virtual reality medium, and (ii) a state in which each user can use a specific virtual reality medium. A change in the association state is a concept including (i) an ownership of a specific virtual reality medium is transferred from one user to another user, and (ii) one user becomes unable to use the specific virtual reality medium and another user becomes able to use the specific virtual reality medium.

A change in the association state of a specific virtual reality medium is realized by assigning the specific virtual reality medium for a fee or without charge (hereinafter also simply referred to as “buying/selling”). In other embodiments, the change in the association state of the specific virtual reality medium may be realized by other transaction forms such as lending.

Hereinafter, another user associated with the specific virtual reality medium is also referred to as a current possessing user of the specific virtual reality medium, and one or more past users with whom the specific virtual reality medium was associated in the past is also referred to as one or more past possessing users of the specific virtual reality medium.

A flea market is a place where a current possessing user of a specific virtual reality medium can assign the specific virtual reality medium to another user.

In the example shown in FIG. 4, user B, who is a possessing user, displays various specific virtual reality media in the metaverse space. In this case, other users visiting the metaverse space can buy desired specific virtual reality media from among various specific virtual reality media displayed by user B via various inputs through the input portion 24. In this case, an association state of a purchased specific virtual reality medium is changed from the state of being associated with user B to the state of being associated with the user who bought the medium. At the time of such purchase, dialogue between the user who makes the purchase and user B (dialogue between avatars) may be realized in the metaverse space.

In the example shown in FIG. 5, user C, who is a possessing user, displays various specific virtual reality media in the non-metaverse space. In this case, other users can buy desired specific virtual reality media from among various specific virtual reality media exhibited by user C through various inputs via the input portion 24. In this case, the association state of the purchased specific virtual reality medium is changed from the state of being associated with user C to the state of being associated with the user who bought the medium.

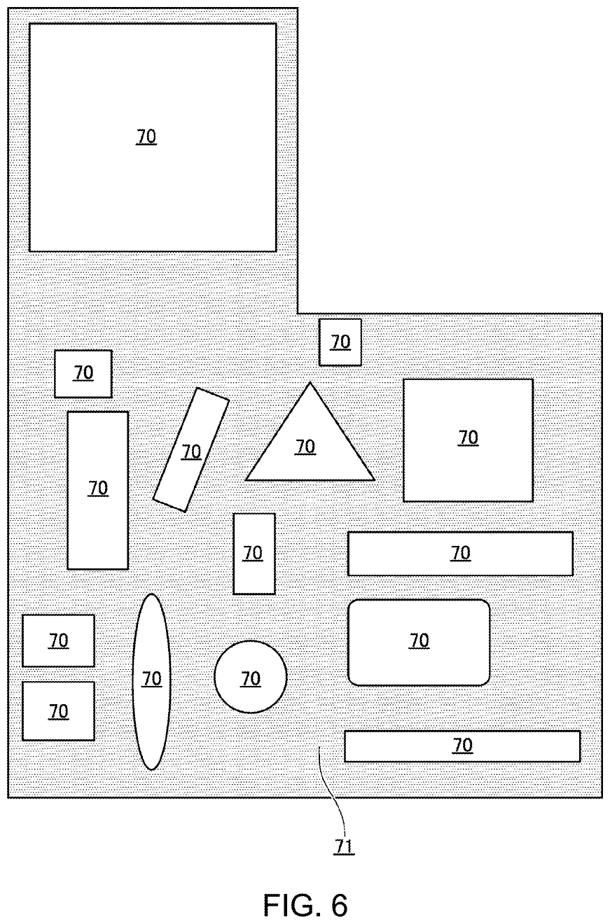

FIG. 6 is an explanatory diagram of an example of a virtual space that can be generated by the virtual reality generation system 1.

In this embodiment, the virtual space may include a plurality of spatial portions. Each of the plurality of spatial portions is a spatial portion that an avatar can enter, and each may be able to provide unique content. Each of the plurality of spatial portions may be generated in a mode of forming spaces that are continuous with each other in the virtual space, similar to various spaces in the real world. Alternatively, some or all of the plurality of spatial portions may be partitioned via walls or doors (second objects), or may be discontinuous with each other. A discontinuity is a relationship that is connected in a way that defies the laws of physics in reality, for example, a relationship between spatial portions that can be moved to and from in the form of teleportation, such as warping.

In the example shown in FIG. 6, the virtual space includes a plurality of flea market spatial portions 70 and a free spatial portion 71. In the free spatial portion 71, an avatar can basically move freely. In the free spatial portion 71 as well, a specific virtual reality medium may be bought and sold between users, as appropriate, such as those realized in a flea market.

Each spatial portion 70 may be a spatial portion at least partially separated from the free spatial portion 71 by a wall (example of a second object) or a movement-prohibiting portion (example of the second object). For example, each spatial portion 70 may have a doorway (for example, a second object such as a hole or a door) through which the avatar can enter and exit the free space portion 71. The spatial portions 70 may function as flea markets. In FIG. 6, although the spatial portions 70 and the free spatial portion 71 are drawn as two-dimensional surfaces, the spatial portions 70 and the free spatial portion 71 may be set as a three-dimensional space. For example, the spatial portions 70 and the free spatial portion 71 may be spaces having walls and ceilings in a range corresponding to a planar shape shown in FIG. 6 as a floor. Apart from the example shown in FIG. 6, other than a space having a height such as a dome or a sphere, or a structure such as a building, or a specific place on the earth, a world that imitates an outer space where an avatar can fly around may be set.

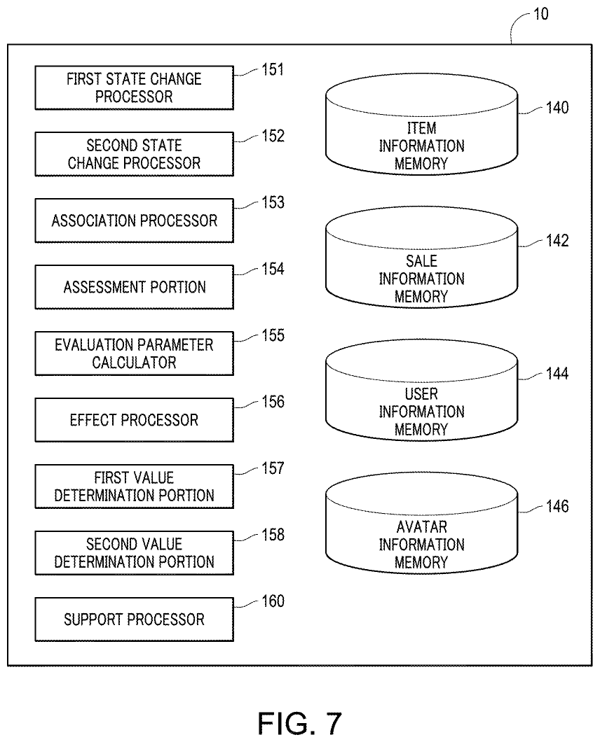

Next, with reference FIG. 7 and after, a functional configuration example of each of the server device 10 and the terminal device 20 related to the flea market described above will be explained. Hereinafter, unless otherwise specified, the specific virtual reality medium is an avatar item that can be attached to an avatar, and a change in the association state of the avatar item is realized through sale of the avatar item at a flea market. The specific virtual reality medium (e.g., avatar item) may be created by the user. For example, the user may create an avatar item that the user designs using a tool prepared by a service provider.

First, with reference to FIGS. 7 to 18, functions of mainly the server device 10 will be explained.

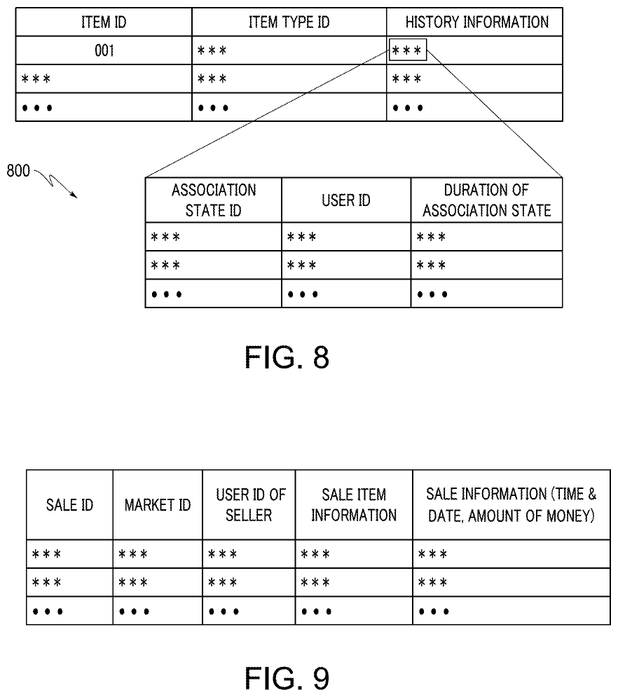

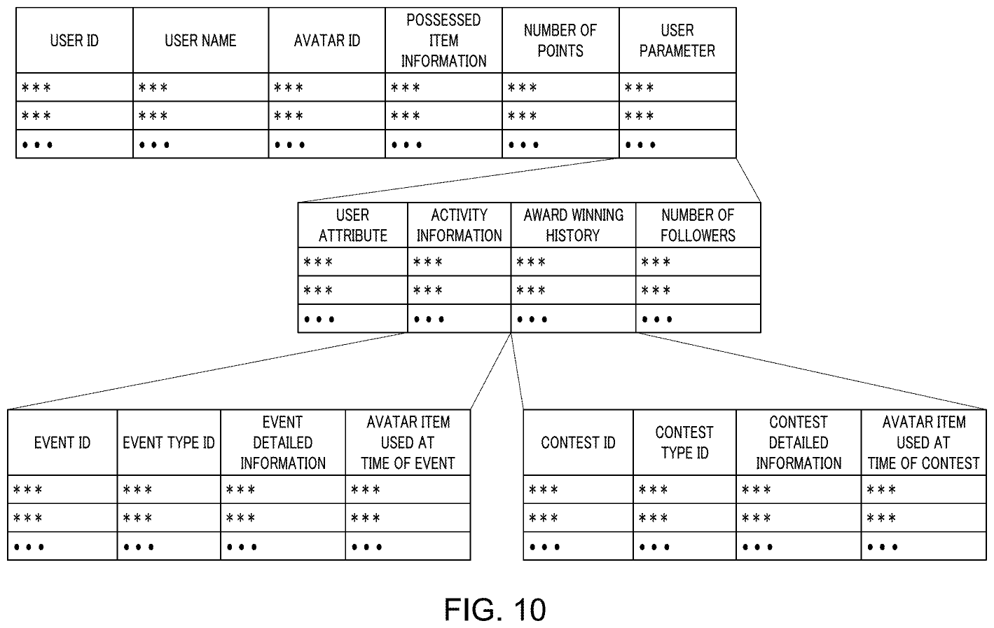

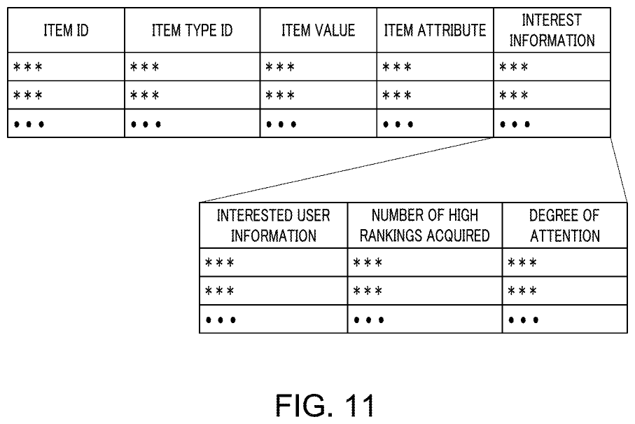

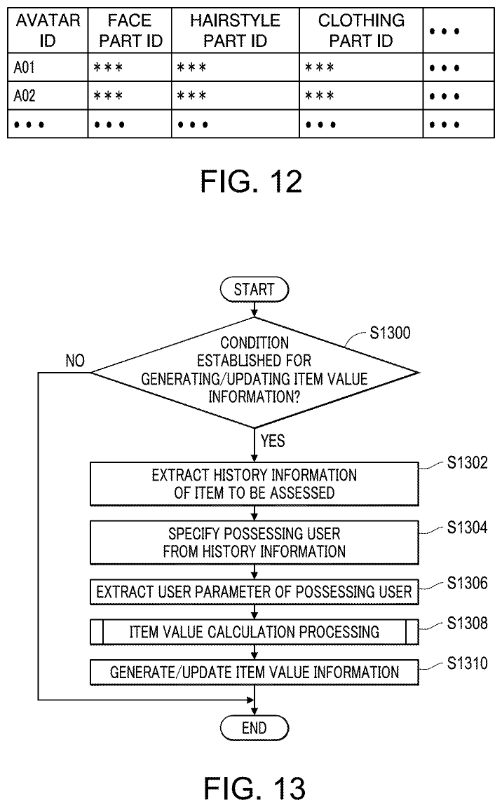

FIG. 7 is a schematic block diagram showing functions of the server device 10 related to the flea market described above. FIG. 8 is an explanatory diagram showing an example of data in an item information memory 140. FIG. 9 is an explanatory diagram showing an example of data in a sale information memory 142. FIG. 10 is an explanatory diagram showing an example of data in a user information memory 144. FIG. 11 is an explanatory diagram of possessed item information. FIG. 12 is an explanatory diagram showing an example of data in an avatar information memory 146. In FIG. 8 (the same applies to similar FIG. 9 and thereinafter), “* * *” indicates a state in which some information is stored, and “⋅ ⋅ ⋅” indicates a repeated state of storing similar information.

As shown in FIG. 7, the server device 10 includes the item information memory 140 (an example of a history memory), the sale information memory 142, the user information memory 144, the avatar information memory 146, a first state change processor 151, a second state change processor 152, an association processor 153, an assessment portion 154, an evaluation parameter calculator 155, an effect processor 156, a first value determination portion 157, a second value determination portion 158, and a support processor 160.

Each memory from the item information memory 140 to the avatar information memory 146 can be realized by the server memory 12 of the server device 10 shown in FIG. 1. The division of the memories from the item information memory 140 to the avatar information memory 146 is for the convenience of explanation, and part or all of the data stored in one memory may be stored in the other memories.

Each processor from the first state change processor 151 to the support processor 160 is appropriately coordinated with the server memory 12 and the server communicator 11 by the server controller 13 of the server device 10 shown in FIG. 1, and can be realized by executing one or more programs in the server memory 12. Similarly, the division of the processors from the first state change processor 151 to the support processor 160 is for the convenience of explanation. A part or all of the functions of one processor may be realized by another processor.

The item information memory 140 stores item information related to all avatar items existing in the virtual space. In the example shown in FIG. 8, the item information includes an item type ID and history information for each item ID.

An item ID is a unique identifier assigned to each avatar item. A unit of an avatar item may be the smallest inseparable unit or may include combined units.

An item type ID is a unique identifier representing the type of avatar item. The gradation of the types of avatar items is arbitrary, but may be, for example, glasses, shoes, clothes, and hairstyles.

The history information relates to the change history of the association state through buying and selling at the above-mentioned flea market and the like. FIG. 8 shows an example of history information 800 related to one item ID. In this case, the history information 800 includes, for each association state ID, a user ID of a possessing user at the time of the association state and duration of the association state. The duration may be information that simply indicates the length, or may be more detailed information such as a period from the year, month, day to the year, month, and day. According to the history information 800, it is possible to specify when, by whom, and for how long each avatar item was possessed. That is, it is possible to specify the current possessing user, the past possessing users, and the possessing period of each possessing user. The history information may be constituted by other information items as long as the current possessing user, the past possessing user, and the possessing period of each possessing user can be specified. For example, the history information may include the initial possessing user, past transaction dates and times, and post-transaction possessing user information.

The sale information memory 142 stores sale information regarding avatar items currently being sold in each market in the virtual space. In the example shown in FIG. 9, the sale information includes market IDs, exhibitors' user IDs, sale item information, and sale information for each sale ID. The market IDs are identifiers assigned to the respective markets when there are a plurality of markets. Market position information and the like may be separately associated with the market IDs. The exhibited item information may include item ID s of exhibited avatar items, item type IDs, and the like. The sale information may include information such as the sale time and date, and the sale price.

User information related to each user is stored in the user information memory 144. In the example shown in FIG. 10, the user information includes a user name, an avatar ID, possessed item information, number of points, and a user parameter for each user ID. Also, the user information may include user profile information that describes the user's profile (hobbies, preferences, activities, and the like).

Each user ID is an ID that is automatically generated at the time of user registration.

Each user name is a name registered by a respective user, and is optional.

Each avatar ID is an ID representing the avatar used by the user. Avatar drawing information for drawing a corresponding avatar may be associated with each avatar ID. The avatar drawing information associated with one avatar ID may be able to be added or edited based on input from the corresponding user. Avatar drawing information may be generated based on an avatar item(s) related to possessed item information.

Possessed item information is various information related to one or more avatar items associated with the corresponding user. FIG. 11 shows an example of possessed item information associated with one user. In the example shown in FIG. 11, the possessed item information includes an item type ID, an item value, an item attribute, and interest information for each item ID. As will be described later, at least one of the item value and the item attribute may be included.

Each item value represents the value of the corresponding avatar item. The value of the avatar item may be a value that correlates with the price at which the item is exhibited at the flea market described above. The item value may be calculated or determined by the association processor 153, which will be described hereinafter, and will be described hereinafter in relation to the association processor 153.

Item attributes may represent special effects (for example, visual effects and the like such as changing light or color, changing a design, making it extravagant, attaching a badge or frame) or functions (for example, functions that can give rewards to participating users, and the like at events, and the like) that may be associated with avatar items. Particularly in the case of avatar items that can be used in games, the item attributes may be attributes that increase offensive and defensive abilities, various skills, or the like. In addition, the item attributes may include attributes that increase an ability of an avatar to which an avatar item is attached. For example, such attributes may increase the number of things that can be performed in the metaverse space (such as being able to fly, teleport, or the like). The item attributes may be calculated or determined by the association processor 153, which will be described hereinafter, and will be described hereinafter in relation to the association processor 153.

Additionally, each item attribute may include a special attribute as an attribute by assigning the special attribute to an avatar item owned by the possessing user of the special attribute. Regarding the assigning of the special attribute, it may be possible for a possessing user of the special attribute to be able to voluntarily assign it. Alternatively, the special attribute may be automatically assigned regardless of the intention of the possessing user. In this case, for example, each item attribute may include an attribute indicating that it is an avatar item worn by the possessing user at a specific event. In this case, the special attribute may indicate that the particular event has a degree of name recognition or popularity that attracts attention from a large number of avatars (users) (for example, winning a top award in the ranking according to the number of gift points received at the specific event). Alternatively, the special attribute may indicate that the avatar (user) has a large number of followers or a large number of viewers, not limited to the specific event.

Interest information is information related to another user's interest with respect to the corresponding avatar item. In the example shown in FIG. 11, the interest information includes user information related to a user who has shown an interest in the corresponding avatar item (hereinafter also referred to as an “interested user”), the number of high ratings acquired for the corresponding avatar item, and the degree of attention. An interested user may be a user who is likely to buy the avatar item, such as a user who has associated a flag such as “Like” or “Favorite” with the avatar item. An interested user may be automatically extracted based on user preference information and the like. The number of high ratings acquired may be managed when the system can give high ratings to the avatar item. Also, the degree of attention may be correlated with, for example, the number of times the avatar item is imaged by a camera, the number of times the line of sight of the user (avatar) is directed to the avatar item, frequency, and the like.

Returning to FIG. 10, the number of points represents the possessed number of predetermined points (an example of electronic media) that can be used for buying and selling avatar items. The predetermined points may be in the form of currency that can be used in the virtual space, or in the form of crypto assets. Also, the predetermined points may be exchangeable for real currency (for example, yen, dollar, or the like), and the exchange rate in this case may vary as appropriate. The user can increase the number of points by spending, for example, real currency or other currency available in the virtual space.

A user parameter is any parameter that can be associated with a user. In the example shown in FIG. 10, user parameters include user attributes, activity information, award winning history, and number of followers. Each item is described below. The user parameters are not limited to these items and their contents, but can include a wide range of items that indicate the user's situation as a parameter that measures user popularity.

A user attribute is an attribute of a user in the virtual space. For example, in contrast to normal attributes, special attributes that are specially given to users with high popularity (famousness), users with great influence (that is, so-called influencers), and users with high status may be prepared. The degree of popularity, the degree of influence, or the like may be correlated with the degree of popularity or the like of a user in reality. Also, a special attribute may be given to a user who hosts or co-sponsors an event as an organizer. Regarding a method of determining whether to give a special attribute, for example, the following may be considered.
Give a special attribute to a user with a predetermined number of followers or more, a predetermined number of distributing viewers or more, and/or a predetermined number of gift receptions or more.
Give a special attribute to a user who has won a high ranking and/or who has a predetermined rank or higher.
Give a special attribute to a user arbitrarily extracted by the management side of the virtual reality generation system 1.
Based on self-reporting from users, give a special attribute to a user who has passed an examination by the management side of the virtual reality generation system 1.

The activity information is a parameter (information) related to the user's activity in the virtual space. For example, in addition to content distribution activities, content viewing activities, live distribution activities, live viewing activities, and the like by users, the user activities are not limited to functions, activities, or entertainment such as games and parties, conversations between users, and movement in the virtual space in which a plurality of users participate, but may include event activities and the like as general activities in a broad sense including various events and occurrences. In the case of an event as a function, an activity, or entertainment, the user's activities include hosting/co-hosting the event, appearing in the event, and participating and watching as a viewer. Specifically, for each activity, the activity information may include the length of stay in the virtual space, the login time and number of times, distribution time, distribution frequency, number of collaborative distributions, and the like. Additionally, collaborative distribution refers to distribution performed in the form of so-called collaboration by a plurality of users who work independently. The activity information may be collected for all users, including users with normal attributes, but preferably may be collected and managed only for users with special attributes. In this case, there is no need to collect/manage activity information for users with normal attributes, so the processing load on the server device 10 can be efficiently reduced.

In the example shown in FIG. 10, when the user hosts or co-hosts as an organizer, activity information includes (i) event IDs that individually specify events when participating or viewing as a viewer in addition to appearances as a performer, (ii) event type IDs that indicate the type and attributes of the events, (iii) detail information that indicates, for example, the date and time of the event and the level of activity (number and duration of sounds (cheers, applause, conversations, and the like), number of images taken, results of evaluation questionnaires, frequency of holding events (degree of serialization, intervals between events, and the like)), scale (number of performers, participants, and visitors), and the like, and (v) information that specifies one or more avatar items used at the time of the event.

The award winning history is history information of the user's winning of awards in the virtual space when the event is in the form of a contest. For example, the award winning history may include the winning history (the number of awards won, the number of championships won, and the like) in various contests that can be executed in the virtual space. Similar to the activity information described above, the award winning histories may be collected for all users including users with normal attributes, but preferably may be collected and managed only for users with special attributes. In this case, there is no need to collect/manage award winning histories for users with normal attributes, so the processing load on the server device 10 can be efficiently reduced.

In the example shown in FIG. 10, the award winning history includes: (i) contest IDs that individually specify the contests that the user participated in as a contestant, (ii) contest type IDs that indicate the type and attributes of the contests, (iii) detail information that indicates the date and time, level of activity (described above), scale (describe above), and the like of the contests, and (iv) information (for example, item IDs) that specifies one or more avatar items used in the contest.

The number of followers represents the number of followers for the user. For example, the number of followers may be calculable when the user is a user who distributes various contents, or it may be possible to calculate the number of followers for all users including users who do not distribute. Additionally, since the user attributes and the number of followers described above can be correlated, only one of them may be used. Also, instead of or in addition to the number of followers, any index value (see below) relating to the evaluation of the activities of the corresponding user by other users, such as the total number of viewers or the number of gifts received, may be used.

Avatar drawing information for drawing each user's avatar is stored in the avatar information memory 146. In the example shown in FIG. 12, in the avatar drawing information, each avatar ID is associated with a face part ID, a hairstyle part ID, a clothing part ID, and the like. Parts information related to appearance such as face part IDs, hairstyle part IDs, and clothing part IDs are parameters that characterize avatars, and may be selected by each user. For example, a plurality of types of information related to the appearance such as a face part ID, a hairstyle part ID, a clothing part ID, and the like related to an avatar are prepared. Also, regarding face part IDs, part IDs may be prepared for each type of face shape, eyes, mouth, nose, and the like. Information related to face part IDs may be managed by combining the IDs of the parts that make up the face. In this case, it is possible to draw each avatar not only at the server device 10, but also at the terminal device 20 side, based on each ID related to the appearance linked to each avatar ID.

The first state change processor 151 changes the association state of avatar items based on the buying and selling of the avatar items between users via a flea market or the like. For example, the first state change processor 151 changes the association state of one avatar item from a state associated with one user to a state associated with another user, based on a combination of the one user's selling instruction (an example of a first input) for the one avatar item and the other user's buying instruction (an example of a second input) for the one avatar item. That is, when the avatar item is bought/sold in the virtual space, the first state change processor 151 changes the user associated with the avatar item from the user that is the seller to the user that is the buyer. Hereinafter, the process of changing the association state of the avatar item by the first state change processor 151 in accordance with such buying/selling is also referred to as “owner change processing.”

Furthermore, when there is an instruction to sell one avatar item from one user (before there is an instruction to buy for the one avatar item from another user), the first state change processor 151 may change the association state of the one avatar item from being associated with the one user to another state. That is, the first state change processor 151 may cancel the association state of the one avatar item with respect to the one user when there is an instruction to sell the one avatar item from the one user.

With the change of the association state by the first state change processor 151, the second state change processor 152 changes the association state of predetermined points of a predetermined value from a state of being associated with the user that is the buyer to a state of being associated with the user that is the seller. The predetermined value corresponds to a selling price (compensation) when the avatar item is bought and sold. That is, when the avatar item is bought and sold in the virtual space, the second state change processor 152 increases the number of points associated with the user that is the seller by the predetermined value and reduces the number of points associated with the user that is the buyer by the predetermined value. Hereinafter, the processing in which the second state change processor 152 changes the association state of the predetermined points according to such buying and selling is also referred to as “settlement processing.” In another embodiment, the settlement processing may be realized by indirect transfer (that is, transfer via a third party) of predetermined points between users instead of direct transfer of predetermined points between users. In this case, the third party may be a user corresponding to a broker.

The association processor 153 generates or updates at least one of item value information and item attribute information (examples of predetermined information) associated with an avatar item based on the change history of the association state of the avatar item and the user information. The avatar items with which at least one of the item value information and the item attribute information is associated may be all avatar items or a part of avatar items (for example, avatar items with a predetermined item type ID). In the case of a part of the avatar items, the part of the avatar items may be determined in any manner. For example, it may include only rare avatar items, or may be selected by a current possessing user, which will be described hereinafter. The change history of the association state may be stored for each avatar item, and each user may be able to check the change history. Specifically, the change history of the association state may be displayed at the display portion 23 of the terminal device 20 of each user together with the avatar item in accordance with the input instruction of each user. At that time, regarding the change history of the association state, when each user taps an avatar item displayed at the display portion 23 of the terminal device 20 of the respective user, the change history of the avatar item may be displayed. Alternatively, an avatar item worn by an avatar and its change history may be displayed in correspondence with each other. Furthermore, the change history of the association state may display the change history of avatar items related to all users, or may display only the change history of avatar items related to users who satisfy a predetermined condition described hereinafter. Alternatively, in the change histories of avatar items for all users, the change histories of avatar items related to users who have satisfied a predetermined condition described hereinafter and users who have not satisfied the predetermined condition may be displayed separately.

Based on the user information related to at least one of the past and current possessing users (hereinafter also referred to as “possessing users” when there is no particular distinction) (an example of a target user) of an avatar item based on the history information of the avatar item, the association processor 153 generates or updates at least one of the item value information and the item attribute information. For example, the association processor 153 may generate or update at least one of the item value information and the item attribute information based on the user information related to a possessing user selected at random from among the one or more possessing users. Alternatively, the association processor 153 may generate or update at least one of the item value information and the item attribute information based on the user information of each possessing user. In this case, at least one of the item value information and the item attribute information may be generated or updated by weighting user information for a specific possessing user (for example, a possessing user with a special attribute) more heavily than other possessing users. Further details of the association processor 153 will be described hereinafter.

The assessment portion 154 determines whether at least one possessing user satisfies a predetermined condition based on the value of a user parameter (an example of a predetermined parameter) related to the possessing user, for each avatar item to be assessed. The value of the user parameter used by the assessment portion 154 for assessment may be the current value, a past value, or a combination of the current value and a past value. The past value may be a value at any point in time prior to the present, for example, the best value or an average value.

The predetermined condition is a condition for determining (i) whether there is an element that increases the item value of the avatar item in the user information (especially the user parameters), and (ii) whether there is an element that increases the item attribute of the avatar item in the user information.

For example, the predetermined condition may include a condition (an example of a first predetermined condition) that is satisfied when the user attribute of the possessing user is or was a predetermined attribute. The predetermined attribute may be a user attribute that increases the item value of the avatar item. Specifically, if a past possessing user or the current possessing user of the avatar item to be assessed has a special attribute such as being a celebrity, the value of all the avatar items possessed by that possessing user increases, and the number of users who want to acquire those avatar items tends to increase. Therefore, in this case, it can be said that such avatar items have an element that increases the item value.

Also, the predetermined condition may include a condition (an example of a second predetermined condition) that is satisfied when the value of a user parameter of the possessing user is or was a predetermined value. As mentioned above, the user parameters include user attributes (number of viewers, number of gifts received, number of points according to the number of gifts received, ranking and rank according to user activity, and the like), activity information (user length of stay in the virtual space, login time and number of times, distribution time, distribution frequency, and the like), award winning history (history of awards received in various contests, and the like), and number of followers (number of followers and total number of viewers, and the like). For example, if the award winning history, which is a user parameter of the possessing user, includes winning such as winning a championship as the predetermined condition, the value of all the avatar items possessed by the possessing user increases, and in particular, the value of a specified avatar item(s) used at the time of winning increases, and the number of users who want to acquire that specified avatar item(s) tends to increase. Therefore, in this case, it can be said that such an avatar item has an element that increases the item value. Here, the avatar item used by the possessing user at the time of winning an award, such as winning a championship, is specified by determining whether the item ID of the avatar item used by the possessing user in the corresponding event matches the item ID of the avatar item to be assessed.

Additionally, the predetermined condition may include a condition (an example of the second predetermined condition) that is satisfied when the value of a user parameter of the possessing user is or was within a predetermined range. For example, when the number of followers, which is the user parameter of the possessing user, is in a range exceeding a threshold value, the value of all the avatar items possessed by the possessing user increases, and the number of users who want to acquire those avatar items tends to increase. Therefore, in this case, it can be said that such an avatar item has an element that increases the item value. Here, for the predetermined condition related to the number of followers, the following items may be used as the arbitrary index value described above. For example, instead of a threshold value, a relative setting such as a top ranking among all possessing users may be used. Furthermore, when the possessing user is in a “mutual follower” relationship with another user (in a state in which different users follow each other), the number of followers of the “mutual followers” may be used as a basis for the predetermined condition of the threshold value or the top ranking. Additionally, instead of the number of followers, the number of friends of the possessing user, the number of other users whose specific information (for example, phone number, email address, predetermined ID, and the like) is stored in the terminal device of the possessing user, or the like may be used as a basis for the predetermined condition. In this manner, the predetermined condition may be appropriately set in various modes.

The evaluation parameter calculator 155 calculates values of evaluation parameters used for assessment by the assessment portion 154. The evaluation parameters may include, for example, user parameters. For example, the evaluation parameter calculator 155 may calculate each value of the user parameters based on each user's activity in the virtual space, and update the user information in the user information memory 144.

Based on the item attribute information associated with the avatar item, the effect processor 156 exerts a predetermined effect on the avatar associated with the avatar item, an avatar in a vicinity of the avatar, or an object in the vicinity of the avatar. For example, if the item attribute is a function that can give rewards to participating users or the like in an event or the like, the effect processor 156 may associate a reward item and/or a predetermined point (or other points) with a hosting user and/or a participating user at an event hosted by an avatar to which the avatar item is attached. Additionally, when the item attribute is a skill that can be used in a game, the effect processor 156 may generate an effect of the corresponding skill in response to an attack performed by the avatar to which the avatar item is attached.

Furthermore, based on the user information related to a past possessing user associated with one avatar item, the effect processor 156 may exert a predetermined effect on the avatar associated with the avatar item, an avatar in a vicinity of the avatar, or an object in the vicinity of the avatar. For example, the effect processor 156 may exert a predetermined effect (for example, an effect associated with a special skill) corresponding to a user attribute associated with the past possessing user, or may make avatars in the vicinity stronger when the avatar associated with the avatar item becomes stronger. Also, for example, the effect processor 156 may cause a special effect to be exerted (i) whenever the avatar item that was worn by the past possessing user at the time of winning an award in an event is worn at the same type of event (whether it is the same type of event is specified by the event type ID described above), and (ii) not limited to that case, whenever the avatar item is worn regardless of the circumstances such as differences in events. In this case, the special effect may be a visual effect (an effect such as changing light or color, changing design, becoming luxurious, attaching a badge or frame, or the like), improvement of a user parameter (changing in a way favorable for the user), or the like. Also, another special effect may be an effect that occurs only when the avatar item is acquired by a follower of a past possessing user. In this case, the visual effect may be a fan mark or the like. In addition, another special effect is that when avatars with the same attribute avatar item gather and play a game together, a user parameter can be improved and the game can proceed in a favorable manner, for example, if the game is a battle, it may be an effect such as improving a parameter such as attack power or the like of each avatar.

Based on at least one of the item value information and the item attribute information associated with one avatar item, the first value determination portion 157 automatically determines the selling price (a “predetermined value” based on a predetermined point of a predetermined value) at the time of buying and selling the one avatar item. The selling price may be determined as a unique price or as a range of prices. Basically, the first value determination portion 157 automatically determines (calculates) the compensation in such a manner that the higher the value of the item value information, the higher the compensation. Similarly, the first value determination portion 157 automatically determines (calculates) the price in such a manner that the higher the value of the item attribute information (the value of ability, function, rarity, or the like), the higher the compensation. Also, the first value determination portion 157 may automatically determine (calculate) the price in such a manner that the higher the type and number of item attributes, the higher the compensation. In this case, a calculation formula may be prepared for determining the compensation for various combinations of at least one of the item value information and the item attribute information.

The second value determination portion 158 determines the selling price (a “predetermined value” based on a predetermined point of a predetermined value) at the time of buying and selling the one avatar item based on user input from the current possessing user related to the one avatar item. In this case, “pricing” that matches the intention of the possessing user is possible. The second value determination portion 158 may function in cooperation with the first value determination portion 157. For example, after the first value determination portion 157 initially determines the selling price related to one avatar item, the initially determined selling price may be presented to the current possessing user (specifically, it may be displayed at the display portion 23 of the terminal device 20B of the current possessing user), and the second value determination portion 158 may change the selling price determined by the first value determination portion 157 based on user input from the current possessing user of the one avatar item. In this case, the second value determination portion 158 may regulate a changeable range according to user input, preferably, so that there is no divergence (particularly a divergence that tends to be increasing) from the selling price initially determined by the first value determination portion 157. For example, the selling price initially determined by the first value determination portion 157 may not be changed by a predetermined percentage or more. As a result, it is possible to suppress unreasonable price hikes and the like, and it is possible to give a sense of security to transactions between users.

The support processor 160 executes a support process for supporting transaction activities related to buying and selling avatar items between users in the virtual space.

The support process may include a notification process of giving a predetermined notification to another user or the like based on an instruction to sell an avatar item from one user. For example, in the support process, prior to or following the instruction to sell from the user who currently possesses the avatar item, the support process may include a notification process for notifying the one user or the other user of at least one of the item value information and the item attribute information associated with the avatar item (avatar item to be sold). The other user may be a user who intends to buy the avatar item or an interested user associated with the avatar item. Such an interested user may be extracted based on the interest information described above (see FIG. 11). Also, the support process may include a notification process for notifying the current possessing user and another user of at least one of the item value information and the item attribute information as well as the sales price determined by the first value determination portion 157. In this case, the selling price determined by the first value determination portion 157 may be used as a fair price. Also, the interested user (or the other user) may be able to access history information of the one avatar item that is on sale and user profile information of the possessing user included in the history information. The user profile information of the possessing user is, for example, the name of the possessing user, text of an introduction of the possessing user, various user parameters of the possessing user, the avatar image of the possessing user, the possessing user's possessed items, the possessing user's activity history (participating events, distributed content, and the like), information and number of other users (followers, friends, and the like) having a predetermined relationship with the possessing user, and the like. Thereby, the user who is considering buying can consider whether to buy the one avatar item while considering the past distribution mode of the one avatar item and the characteristics of the possessing user. Additionally, by viewing the user profile information of the possessing user, the user who is considering buying follows the possessing user, becomes friends with the possessing user, communicates with the possessing user via chatting and the like, and views distribution, which can contribute to activation of communication between the users.

Furthermore, the support process may include, for example, a process for notifying an interested user associated with the avatar item that the avatar item will be listed for sale, based on an instruction to sell from the current possessing user of the avatar item. In this case, the interested user may be extracted based on the interest information described above (see FIG. 11). The notification that an avatar item is listed for sale may include detailed information regarding the avatar item (for example, item value information, item attribute information, sales price, sales location, and the like, and/or history information). In addition, the notification may include a user interface (UI) that serves as a lead to buying, such as moving from the notification to a purchase location or transitioning to a buying screen. By receiving such notification, the interested user can easily access the information regarding the avatar item and decide whether to buy. Also, the interested user does not need to visit many markets in the virtual space in search of the avatar item; thus, it is possible to reduce the user's load and promote transactions of avatar items. Additionally, since it is possible to reduce the amount of operations and the amount of communication until the interested user buys the desired avatar item, the processing load and communication load of the virtual reality generation system 1 can be reduced.

Additionally, when at least one of the item value information and the item attribute information associated with the avatar item is updated (changed), the support process may include a process for notifying the current possessing user of the update (change). For example, a message such as “Your hat has changed from 200 to 300 coins!” may be output. In this case, the user may be able to confirm a factor that caused the change in at least one of the item value information and the item attribute information. Furthermore, the message may include a user interface (UI) for receiving an instruction to sell. In this case, for example, the user can grasp that the reason why the item value information has changed is because the number of followers of user Mr./Ms. X, who once possessed this hat, has exceeded 5000. Such a notification can trigger the user to list an avatar item, effectively promoting the activation of the flea market.

Next, with reference to FIG. 13, various operation examples that may be realized in the virtual reality generation system 1 described above will be explained.

FIG. 13 is a schematic flowchart showing an example of processing for generating or updating item value information.

In step S1300, the association processor 153 of the server device 10 determines whether a condition for generating or updating the item value information (hereinafter referred to as “generating/updating condition”) is established. The condition for generating/updating the item value information is arbitrary, but may be appropriately set from the viewpoint of reducing the processing load. For example, among the condition for generating/updating the item value information, the update condition may be satisfied when there is a request (for example, an appraisal request) from the current possessing user of the avatar item, or when the avatar item is used by the current possessing user. Also, the update condition may be executed at intervals of days or longer, such as every day or every week. Additionally, regarding the update condition, the condition for generating/updating the item value information may be established in conjunction with the schedule of the flea market (for example, only on weekends). Also, among the condition for generating/updating the item value information, the generation condition may be satisfied when a new avatar item is generated. If the determination result is “YES,” the process proceeds to step S1302; otherwise, the process ends as-is. A new avatar item may be generated by the operator of the virtual reality generation system 1, or may be generated by the user.

In step S1302, the association processor 153 extracts history information (see FIG. 8) associated with the avatar item to be assessed (described as “target item to be assessed” in FIG. 13).

In step S1304, the association processor 153 specifies the possessing users (current possessing user and past possessing user(s)) based on the history information extracted in step S1302.

In step S1306, the association processor 153 extracts each value of the user parameters (see FIG. 10) of the possessing users specified in step S1304.

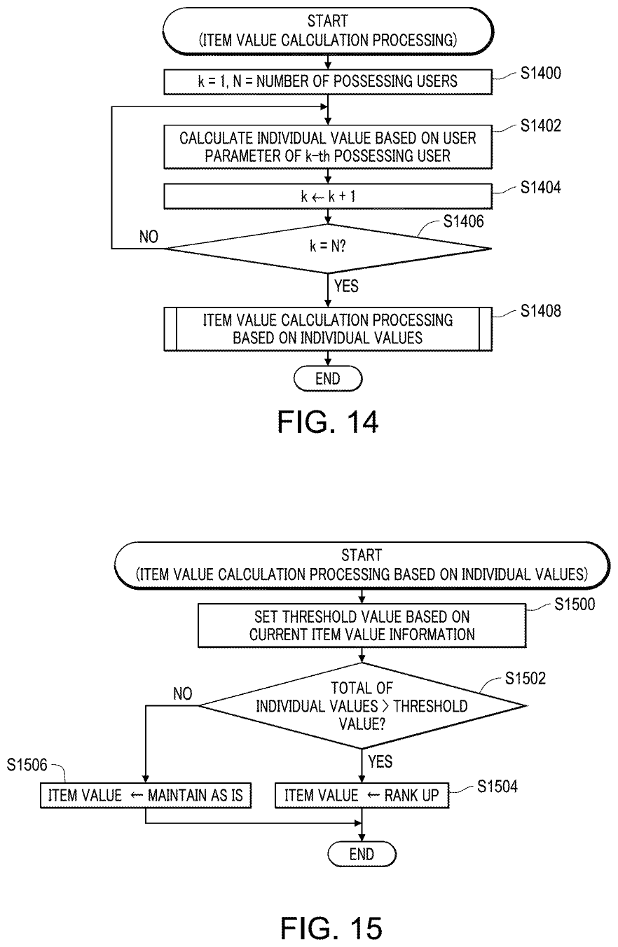

In step S1308, the association processor 153 executes an item value calculation process that calculates the item value related to the avatar item to be assessed, based on each value of the user parameters (see FIG. 10) of the possessing users extracted in step S1306. A specific example of the item value calculation process will be described later with reference to FIG. 14.

In step S1310, the association processor 153 generates or updates possessed item information (item value information) in the user information memory 144, based on the calculation result of the item value obtained in step S1308.

FIG. 14 is a schematic flowchart showing an example of the item value calculation process (step S1308 in FIG. 13).

In step S1400, the association processor 153 sets k=1, and N=the number of possessing users. The number of possessing users is the number of possessing users related to the avatar item to be assessed.

In step S1402, the association processor 153 calculates an individual value of the k-th possessing user that contributes to the value of the avatar item to be assessed, based on each value of the user parameter of the k-th possessing user. A method of calculating the individual value of the k-th possessing user is arbitrary, but may be calculated as follows, for example. Based on each value of the user parameter of the k-th possessing user, the individual value of the k-th possessing user may be calculated in such a manner that (i) the individual value of the k-th possessing user is higher in the case of a special attribute than in the case of not having the special attribute, (ii) the individual value of the k-th possessing user increases as the activity information (for example, the number of activity events and distribution frequency) increases, (iii) the individual value of the k-th possessing user increases as the award winning history increases, and/or (iv) the individual value of the k-th possessing user increases as the number of followers increases.

In step S1404, the association processor 153 increments k by “1.”

In step S1406, the association processor 153 determines whether k=N (set in step S1400). If the determination result is “YES,” the process proceeds to step S1408; otherwise, the process proceeds to step S1412.

In step S1408, the association processor 153 executes an item value calculation process for calculating a final value (total value) of the avatar item as an item value, based on the individual values of the N possessing users calculated in step S1402. The item value calculation process may be a process for calculating the final value by adding up the individual values of N possessing users. At this time, the individual values of the possessing users may be added up with the same weighting, or may be added up with different weightings. In the latter case, the weight assigned to the individual value associated with each possessing user may be assigned in such a manner that the longer the duration of the association state associated with each possessing user, the greater the weight. A more specific example of the item value calculation process will be described hereinafter with reference to FIG. 15 and the like.

FIG. 15 is a schematic flowchart showing an example of the item value calculation process (step S1408 in FIG. 14) based on the individual values.

In step S1500, the association processor 153 sets a threshold value for the avatar item to be assessed based on the current item value information associated with the avatar item. The threshold value may be set in such a manner that the higher the value that is based on the current item value information, the higher the threshold value.

In step S1502, the association processor 153 determines whether the total individual value of each possessing user exceeds the threshold value. In another embodiment, the association processor 153 determines whether the individual value (for example, the largest individual value) related to a specific possessing user exceeds the threshold value. In this case, the threshold value set in step S1500 may be adapted to a single individual value. Alternatively, the association processor 153 may determine whether the average value of the individual values of the possessing users exceeds the threshold value. In this case, even if the individual value associated with one possessing user is extremely high, the average value is less likely to exceed the threshold value (that is, the value will diminish) when the number of possessing users increases. If the determination result is “YES,” the process proceeds to step S1504; otherwise, the process proceeds to step S1506.

In step S1504, the association processor 153 ranks up the item value associated with the avatar item to be assessed (changes in in a way favorable for the possessor). For example, when item values are ranked, the association processor 153 ranks up the item values. The item value may be calculated by the number of points of predetermined points. In this case, the association processor 153 may increase the number of points of the predetermined points by a predetermined percentage instead of increasing the rank.

In step S1506, the association processor 153 sets the item value associated with the target avatar item to be assessed to be maintained as is. In this case, since the item value information does not change, the process itself of step S1310 in FIG. 13 may be omitted.

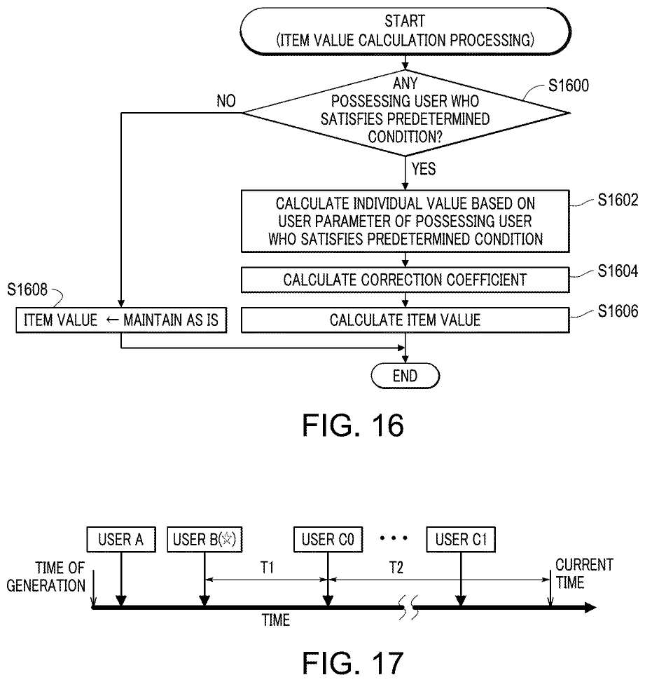

FIG. 16 is a schematic flowchart showing another example of the item value calculation process (step S1308 in FIG. 13). FIG. 16 shows a case where a correction coefficient is used in the item value calculation process (step S1604), but the correction coefficient may be omitted as described hereinafter. FIG. 17 is an explanatory diagram of the process of FIG. 16, and is an explanatory diagram of a calculation method when the correction coefficient is used.

In step S1600, the association processor 153 determines whether there is a possessing user who satisfies a predetermined condition among all possessing users related to the avatar item to be assessed. The predetermined condition may be as described above. In FIG. 16, as an example, it is assumed that the predetermined condition is satisfied when the user attribute of the possessing user is a special attribute. If the determination result is “YES,” the process proceeds to step S1602; otherwise, the process proceeds to step S1608.

In step S1602, the association processor 153 calculates an individual value based on a user parameter(s) of the possessing user who satisfies the predetermined condition. The method for calculating the individual value may be as described above with reference to step S1402 in FIG. 14.

In step S1604, if not omitted, the association processor 153 calculates a correction coefficient based on the history information extracted in step S1302.

Incidentally, the greater the number of variations in value fluctuation factors, the greater the interest in buying and selling avatar items, and the more the flea market can be activated. For this reason, the correction coefficient may preferably be calculated in various manners so as to increase the variation of such price fluctuation factors. For example, when history information of the avatar item includes an association state of a possessing user that satisfies a predetermined condition, the correction coefficient may be calculated so that the value of the avatar item increases as the duration of the association state of the possessing user increases. This is because there is a high possibility that the possessing user used it by that amount (possibility that he liked it and used it). Furthermore, even if the history information of the avatar item includes the association state of a possessing user who satisfies the predetermined condition, if the number of association states of a possessing user(s) who does not satisfy the predetermined condition (that is, a possessing user having a normal attribute) is large, the correction coefficient may be calculated to reduce the value by that amount. Additionally, even if the history information of the avatar item includes the association state of a possessing user who satisfies the predetermined condition, the correction coefficient may be calculated so that the longer the elapsed time after the possessing user let the item go, the more the value decreases.

Specifically, FIG. 17 schematically shows history information related to one avatar item in chronological order. In the example shown in FIG. 17, user A to user Cl are the possessing users, and user Cl is the current possessing user. It is also assumed that user B is a user who satisfies a predetermined condition. In this case, the association processor 153 may calculate a correction coefficient such that the longer the possession period (duration of the association state) T1 of user B, the higher the final value (item value) of the avatar item. Alternatively, the association processor 153 may calculate a correction coefficient such that the longer the elapsed period (period at user C0 and after) T2 after user B lets the item go, the lower the item value. Alternatively, the association processor 153 may calculate a correction coefficient such that the higher the number of possessing users after user B lets the item go (number of possessing users at user C0 and after, that is, number of changes in the association status at user C0 and after), the lower the final value (item value) of the avatar item. Additionally, a predetermined upper limit value may be set for the correction coefficient. Furthermore, in the history information related to one avatar item, if there is a plurality of users who satisfy a predetermined condition, the correction coefficient described above may be calculated in consideration of all users. Alternatively, the above-described correction coefficient may be calculated based on the most recent user (user who satisfies a predetermined condition) among a plurality of users, or based on a user other than the most recent user, such as a user specified based on some condition such as having a large number of followers (for example, a predetermined number or higher).

Additionally, the association processor 153 may calculate the correction coefficient such that based on history information related to one avatar item, the greater the number of possessing users over the entire period in which the one avatar item exists (that is, the number of association state changes over the entire period, including the first time), the lower or higher the final value (item value) of the avatar item. In this case, it may be irrelevant whether the possessing users related to the one avatar item include users who satisfy the predetermined condition. Alternatively, while the association processor 153 may calculate the correction coefficient such that if the possessing users related to the one avatar item include a user(s) who satisfies a predetermined condition, the greater the number of possessing users over the entire period in which the one avatar item exists, the lower the final value of the avatar item, the association processor 153 may calculate the correction coefficient such that if the possessing users related to the one avatar item do not include any users who satisfy a predetermined condition, the greater the number of possessing users over the entire period in which the one avatar item exists, the higher the final value of the avatar item.

In step S1606, the association processor 153 calculates the final value of the avatar item as the item value based on the individual value obtained in step S1602, and based on the correction coefficient obtained in step S1604 if not omitted. For example, it may be calculated as item value=K1×individual value. Here, K1 is the correction coefficient obtained in step S1604. If it is greater than or equal to 1, it is corrected to increase the individual value. The correction coefficient may be calculated based on various factors as described above. In this case, the correction coefficient K1 may be a combination of correction coefficients related to multiple factors. Step S1604 may be omitted, and if omitted, in step S1606, the association processor 153 calculates the final value of the avatar item as the item value, based on the individual value obtained in step S1602.

In step S1608, the association processor 153 sets the item value associated with the avatar item to be assessed to be maintained as is. In this case, since the item value information does not change, the process itself of step S1310 in FIG. 13 may be omitted.

In the example shown in FIG. 16, the correction coefficient may be calculated considering factors other than those described above. For example, the correction coefficient may be calculated in consideration of activity information or award winning history. In this case, if the avatar item to be assessed was used in an important event or contest, the correction coefficient may be calculated in such a manner that the item value becomes higher than otherwise. Thus, in calculating the correction coefficient, information regarding how the avatar item to be assessed was used by the corresponding possessing user (for example, in what type of event it was used, how often was it used, when it was used, or the like) may be considered.

In the example shown in FIG. 16, the concept of the correction coefficient is used, but equivalently, the final value of the avatar item may be directly calculated using the factors considered in the calculation of the correction coefficient.

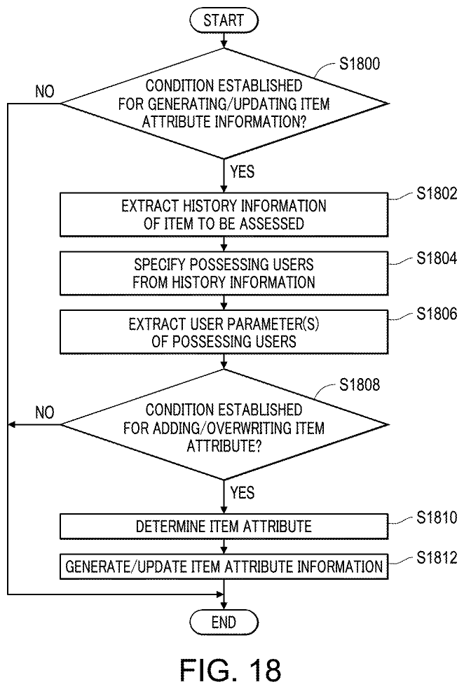

FIG. 18 is a schematic flowchart showing an example of processing for generating or updating item attribute information.

In step S1800, the association processor 153 of the server device 10 determines whether a condition for generating/updating the item attribute information is established. The condition for generating/updating the item attribute information is arbitrary, but may be appropriately set from the viewpoint of reducing the processing load. For example, the condition for generating/updating the item attribute information may be the same as the condition for generating/updating the above-described item value information, and may be satisfied at the same time. If the determination result is “YES,” the process proceeds to step S1802; otherwise, the process directly ends.

In step S1802, the association processor 153 extracts history information (see FIG. 8) associated with the avatar item to be assessed (described as “target item to be assessed” in FIG. 18).

In step S1804, the association processor 153 specifies the possessing users (current possessing user and past possessing user), based on the history information extracted in step S1802.

In step S1806, the association processor 153 extracts each value of the user parameter(s) (see FIG. 10) of the possessing users specified in step S1804.

In step S1808, the association processor 153 determines whether the condition for adding/overwriting the item attribute is established based on each value of the user parameter(s) (see FIG. 10) of the possessing users extracted in step S1806. The condition for adding/overwriting the item attribute is arbitrary, but may be satisfied (i) if an avatar item that was used when winning an award in a contest and the like, or at a commemorative event or the like, was the avatar item to be assessed, (ii) if the number of distributions by avatars having attached thereto the avatar item to be assessed exceeds a threshold value, (iii) if the avatar item was attached to a user who satisfies a predetermined condition (for example, a user with a predetermined number of followers or higher) at a specific event, or the like. If the determination result is “YES,” the process proceeds to step S1810; otherwise, the process ends.

In step S1810, the association processor 153 determines the item attribute to be added or overwritten. In this case, the item attribute to be added or overwritten is an item attribute that is more favorable for the possessing user than the current item attribute, and may be set in advance for each condition for adding/overwriting the item attribute. Alternatively, the item attribute to add or overwritten may be set at random or may be selectable by the user. For example, in the case of an avatar item that can be used in a game, the item attribute may be an attribute that increases offensive or defensive capabilities, various skills, or the like. In this case, it may be added in such a way that an item attribute constructed by a past possessing user is inherited. As a result, for example, an avatar item used by an old hero (past possessing user) when he defeated an enemy may inherit an item attribute that can generate a buff effect when fighting a similar enemy. In this way, item attributes may accumulate according to successive enemies defeated.

Additionally, for example, when an avatar wearing one avatar item attends a commemorative event, many users tend to want to acquire the avatar item at that time. Therefore, in this case, it can be said that the avatar item has an element that increases the item value. Thus, in this case, the avatar item may be provided with a special item attribute. Also, when an avatar wearing one avatar item wins a contest, the avatar item may be provided with a special item attribute. In this case, the avatar item may have an element that improves the item attribute, such as the ability to win the contest. Therefore, in this case, the avatar item may be provided with a special item attribute.

In step S1812, the association processor 153 adds or overwrites the item attribute determined in step S1810 to generate or update possessed item information (item attribute information) in the user information memory 144.

Furthermore, in the example shown in FIG. 18, the condition for generating/updating the item attribute information may be constituted by the condition for adding/overwriting the item attribute described above with reference to step S1808, or may include the condition for adding/overwriting the item attribute described above with reference to step S1808. For example, if an avatar to which is attached a certain avatar item wins a contest or the like, if the condition for adding/overwriting the item attribute (and the condition for generating/updating the item attribute information) is satisfied, the process of step S1810 may be executed for the avatar item based on the event of winning the contest (event related to an activity parameter) or the like.

Thus, according to this embodiment, the item value and the item attribute that are associated with an avatar item can be generated or updated based on the history information of the one avatar item (and the user information of the possessing user related to the history information). As a result, activation of various transactions related to the avatar item in the virtual space can be effectively promoted.

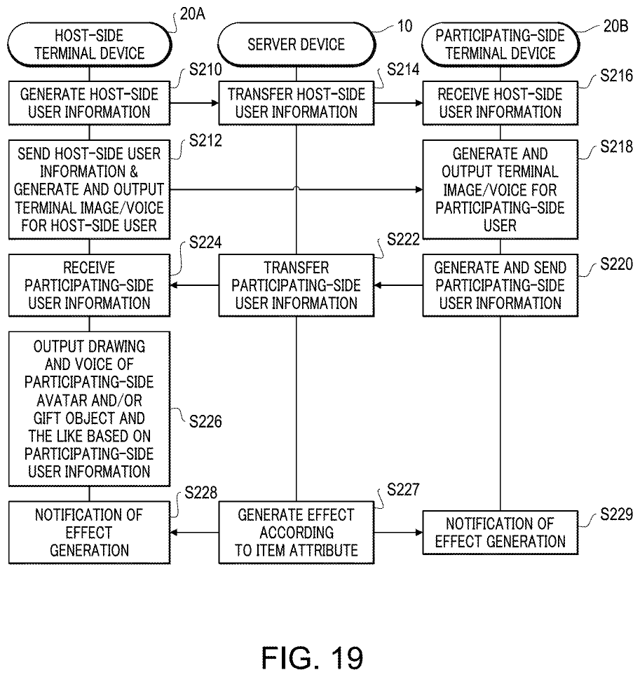

FIG. 19 (i) shows operations of the host-side terminal device 20A, the participating-side terminal device 20B, and the server device 10 that are executed in the virtual reality generation system 1 shown in FIG. 1, and (ii) is a flowchart showing an example of the operations during distribution of digital content by the host-side user.

In FIG. 19, the left side shows the operations performed by the one host-side terminal device 20A, the center shows the operations performed by the server device 10 (one server device 10 here), and the right side shows the operations performed by one participating-side terminal device 20B.

In step S210, the host-side user starts distribution related to an activity event, and performs various movements (including speaking movements related to conversation) to realize various movements of the host-side avatar. As a result, the host-side terminal device 20A can generate host-side user information according to the various movements of the host-side avatar. The host-side terminal device 20A sends, to the server device 10, such host-side user information as terminal data for the terminal device 20B. As long as a condition is met in which the host-side user information indicates that the correspondence relationship between transmitting (transmitted) information and a time stamp based on a reference time is clear in both the host-side terminal device 20A and the participating-side terminal device 20B, the host-side user information may be multiplexed together by an arbitrary multiplexing method and sent to the server device 10. If such a condition is satisfied, the participating-side terminal device 20B can appropriately process according to the time stamp corresponding to the host-side user information when the host-side user information is received. For the multiplexing method, the host-side user information may each be sent via separate channels, or part of the host-side user information may be sent over the same channel. A channel may include a timeslot, a frequency band, and/or a spreading code, and the like. A method of distributing a video (digital content) using a reference time may be realized in a manner disclosed in Japanese Patent No. 6803485, which is incorporated in the specification of this application by reference.

Next, in parallel with the operation in step S210, in step S212, the host-side terminal device 20A continuously sends the host-side user information for drawing a virtual space image for the participating-side user to the participating-side terminal device 20B via the server device Additionally, the host-side terminal device 20A outputs, to the host-side terminal device the virtual space image (not depicted) for the host-side user.

The host-side terminal device 20A can perform the operations in steps S210 and S212 in parallel with the operations in steps S214 to S222 described below.

Next, in step S214, the server device 10 sends (transfers) the host-side user information continuously sent from the host-side terminal device 20A to the participating-side terminal device 20B.

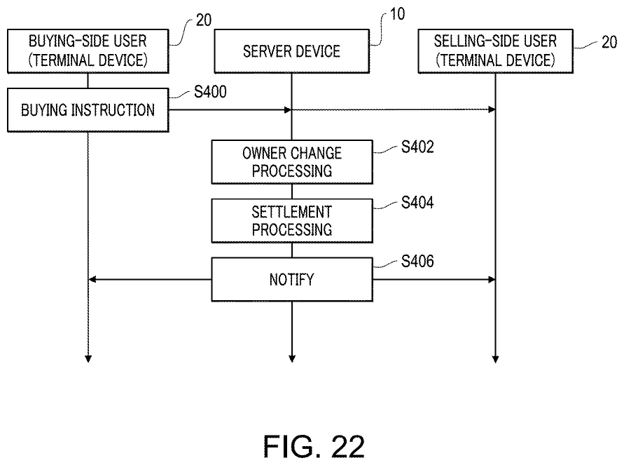

In step S216, the participating-side terminal device 20B receives the host-side user information from the server device 10 and stores it in the terminal memory 22. In one embodiment, considering the possibility that sound information may have a larger capacity than other information and/or the possibility of communication line failure, the participating-side terminal device 20B can temporarily store, in the terminal memory 22 (see FIG. 22), the host-side user information received from the server device 10.

In parallel with receiving and storing such host-side user information, in step S218, the participating-side terminal device 20B uses the host-side user information received from the host-side terminal device 20A via the server device 10 and stored so as to generate a virtual space image for the participating-side user and play digital content.

In parallel with the operations in steps S216 and S218 described above, in step S220, the participating-side terminal device 20B generates participating-side user information, and sends the participating-side user information as terminal data related to the terminal device 20A to the host-side terminal device 20A via the server device 10. The participating-side user information may be generated, for example, only when the participating-side user inputs a conversation-related input, performs an operation to give a gift, or the like.

In step S222, the server device 10 sends (transfers) the participating-side user information received from the participating-side terminal device 20B to the host-side terminal device 20A.

In step S224, the host-side terminal device 20A can receive the participating-side user information via the server device 10.

In step S226, the host-side terminal device 20A can basically perform the same operation as in step S210. For example, the host-side terminal device 20A may generate drawing instructions for the participating-side avatar and/or gift drawing instructions based on the participating-side user information received in step S224, and draw the corresponding participating-side avatar and/or a gift object in the virtual space image. If a sound output instruction is generated in addition to the drawing instruction, drawing and sound output may be performed.

Thus, the processing shown in FIG. 19 may be continuously executed until the distribution of the digital content by the host-side user ends or until there are no participating-side users of the digital content. Then, when distribution of the digital content by the host-side user ends, the above-described effect processor 156 generates a predetermined effect (for example, giving a reward or the like) based on the item attribute information of the avatar item attached to the host-side avatar (step S227). When the predetermined effect is generated, a notification to that effect may be sent to the host-side user and the participating-side user (steps S228, S229).

In the example shown in FIG. 19, the execution subject of each process can be changed in various aspects as described above. For example, in the process of step S212, the process for generating a virtual space image (undepicted) for the host-side user may be realized by the server device 10 instead of the terminal device 20A. Furthermore, in the process of step S218, the process for generating a virtual space image for the participating-side user may be realized by the terminal device 20A or the server device 10. In this case, in step S216, data for the virtual space image for the participating-side user may be received instead of the host-side user information. Additionally, in the process of step S226, the process for drawing a gift object in the virtual space image (undepicted) for the host-side user based on the participating-side user information may be realized by the server device 10 instead of the terminal device 20A.

Additionally, in the example shown in FIG. 19, although the roles of the host side (content distribution side) and the participant side (content viewing side) are distinguished, there is no need to distinguish between these roles. For example, in a world-type virtual space in which each avatar can freely move around, as described above, the distinction between the roles of participating avatars and host avatars is for convenience of explanation, and there may be no substantial difference between the avatars. That is, in a virtual space in which each avatar can freely move around, each terminal image is an image showing the state of the virtual space from the viewpoint of a respective virtual camera, so there is no need to distinguish roles.

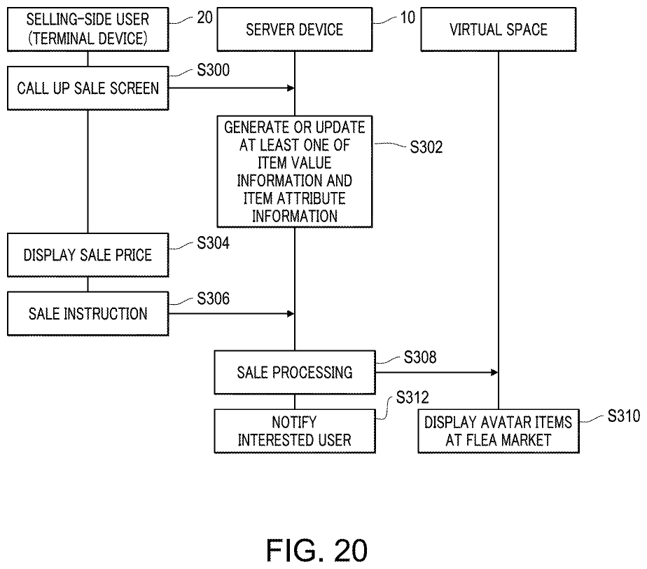

Next, with respect to FIGS. 20-22, a flow of processing at the time of a transaction related to a flea market in the virtual space will be outlined.

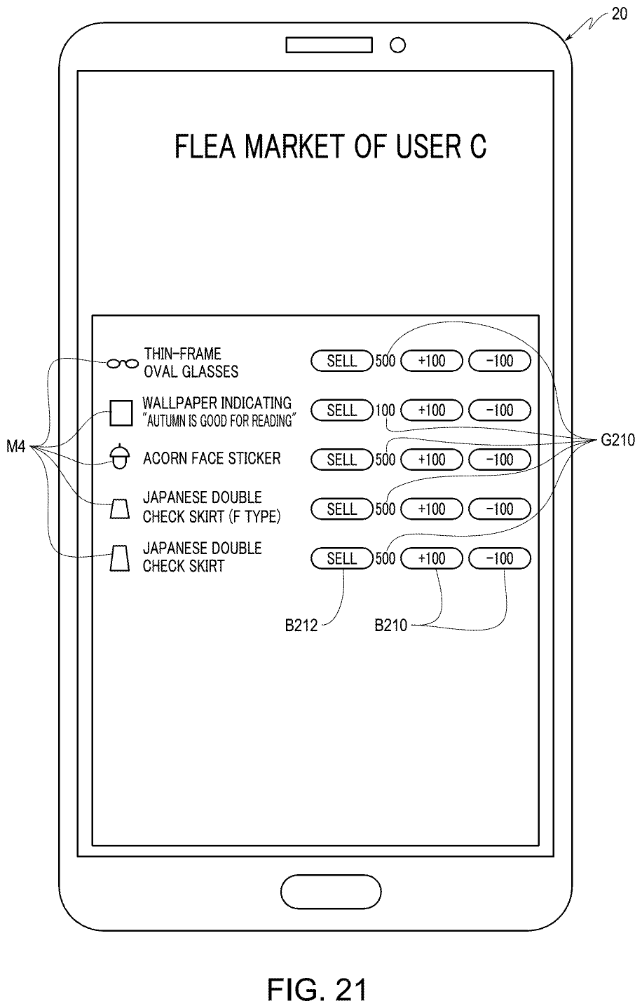

FIG. 20 is a timing chart schematically showing the flow of processing when a selling-side user sells an avatar item at a flea market in the virtual space. FIG. 21 is an explanatory diagram showing an example of a flea market-related screen on a smartphone or the like (an example of the terminal device 20). FIG. 22 is a timing chart schematically showing the flow of processing when a buyer-side user buys an avatar item listed at a flea market in the virtual space.

The selling-side user uses his/her own terminal device 20 to call up a sale screen (step S300). Instead of calling up the sale screen, it is also possible for the selling-side user to become an avatar and directly visit the flea market in the metaverse space. At this time, the selling-side user may designate an avatar item that the user wishes to sell.

Next, the server device 10 generates or updates at least one of the item value information and the item attribute information of the avatar item associated with the selling-side user (for example, the avatar item specified by the same user) (step S302), and presents the sale price at the time of buying and selling the avatar item (step S304). Additionally, the selling price for buying and selling the avatar item may be the selling price determined by the first value determination portion 157 described above. FIG. 21 shows an example of a screen that determines sale prices with respect to five avatar items M4. In this case, numerical values G210 may be the selling prices determined by the first value determination portion 157 described above. The user may operate price adjustment buttons B210 to adjust the selling price to a desired price. Then when the user sets the selling price of each avatar item to the desired price, he sends sale instructions to the server device 10 by operating the sale buttons B212 (step S306). The sale button B212 may be set for each avatar item M4 as shown in FIG. 21, or may be set as a collective button. Although not shown in FIG. 21, the sale instructions may include information specifying the flea market where items are to be sold. If the selling-side user becomes an avatar and directly visits the flea market in the metaverse space, s/he can generate similar sale instructions by directly negotiating with a flea market manager avatar, or the like.

When the server device 10 receives the sale instructions, the server device 10 executes the sale process according to the sale instructions (step S308). As a result, the avatar items that are on sale are displayed in the flea market (step S310). Therefore, other users can visually recognize the avatar items that are on sale via avatars visiting the flea market.

Also, when the server device 10 receives such sale instructions, it updates the data in the sale information memory 142 and may present (notify) sale information to an interested user based on interested-user information (see FIG. 11) associated with the avatar items that are on sale (step S312).

Continuing to FIG. 22, when the buyer-side user finds a desired avatar item in the virtual space, a buying instruction is sent to the server device 10. The buying instruction may be notified to the selling-side user of the flea market (step S400). In response to the buying instruction, the server device 10 executes (i) owner change processing (step S402) by the first state change processor 151 described above and (ii) settlement processing (step S404) by the second state change processor 152 described above. Then, the server device 10 may notify both users of the transaction result (step S406).

Although various embodiments have been described in detail above, it is not limited to a specific embodiment, and various modifications and changes are possible within the scope of the claims. It is also possible to combine all or a plurality of structural elements of the above-described embodiments.

For example, in the above-described embodiments, a flea market by individual users was a place to buy and sell avatar items, but it can also be applied to selling avatar items to buyer-side users and the like (for example, buying agent users) in the virtual space. In this way, the form of sales of avatar items is arbitrary.

Additionally, in the above-described embodiments, although no particular reference is made to rules and the like for sales at the flea market, the rules and the like may be set as appropriate. For example, when a transaction is established, the selling-side user may be charged a commission of a predetermined percentage, or the selling-side user may be charged a usage fee for using the spatial portion 70. Also, in the virtual space, it may be possible to display various advertisements for the avatar items that are on sale at the flea market. Also, in the above-described embodiment, the final selling price of an avatar item that is on sale at the flea market may be determined in an auction format.

Further, in the above-described embodiments, the history information associated with the avatar item may be able to be output (published) in a form that cannot be falsified. In this case, the avatar item may be allowed to be brought into another metaverse space based on another platform. Alternatively, conversely, avatar items may be brought in from other metaverse spaces. In this case, the item value and the item attribute may be calculated with respect to the avatar item, using the history information associated with the avatar item on another platform.

Further, in the above-described embodiments, at least one of the item value information and the item attribute information is associated with an avatar item. However, depending on the item type, only one of the item value information and the item attribute information may be associated with all avatar items. Additionally, at least one of the item value information and the item attribute information associated with one avatar item is generated or updated based on the history information and the user information. However, only one of the item value information and the item attribute information may be generated or updated based on the history information and the user information.

Also, in the above-described embodiments, the item value and the item attribute associated with one avatar item are parameters independent of each other, but they may be mutually dependent (or in a cooperative relationship). For example, an item attribute associated with one avatar item may be changed to an item attribute that is more favorable as the item value associated with the one avatar item increases.

Further, in the above-described embodiments, the item value associated with one avatar item is generated or updated based on the history information of the one avatar item (and the user information of the owner user related to the history information), but other factors may be considered in combination. In this case, the other factors may include the rarity of the avatar item itself, interest information (the number of interested users, the degree of attention, or the like) associated with the avatar item, the level, some parameters such as abilities, the number of times the item is combined or reinforced, and the like. In this case, the item value associated with one avatar item is generated or updated in such a manner that (i) the higher the rarity (the more rare the item is), the higher the value, and (ii) the higher the number of interested users or the higher the degree of attention, the higher the value.

Additionally, in the above-described embodiments, as mentioned above, item attributes are diverse. However, for example, item attributes linked to user attributes, activities, and the like of a possessing user may be set. For example, when a distributor recommended by the possessing user of one avatar item has an attribute of distributor A, the one avatar item may be given an item attribute that produces an effect when participating in distribution or an event of distributor A. Also, an item attribute may be given that produces an effect when performing a predetermined activity (collaborative distribution, a conversation in the metaverse space, playing a game together, a video chat) with a user have attached thereto an avatar item with the same item attribute. In these cases, the usefulness of being able to access the user profile information of the possessing user becomes significant. Furthermore, for special virtual reality media that are not on sale in a market in the virtual space, contents such as item attributes, item values, predetermined effects, and the like are displayed on the display portion 23 of the terminal device of the possessing user. The special virtual reality media that are placed on sale in the market in the virtual space are displayed on the display portion 23 of the terminal device 20 of each user.
1 virtual reality generation system
3 network
10 server device
11 server communicator
12 server memory
13 server controller
20A, 20B terminal devices
21 terminal communicator
22 terminal memory
23 display portion
24 input portion
25 terminal controller
70 spatial portion
71 free spatial portion
140 item information memory
142 sale information memory
144 user information memory
146 avatar information memory
151 first state change processor
152 second state change processor
153 association processor
154 assessment portion
155 evaluation parameter calculator
156 effect processor
157 first value determination portion
158 second value determination portion
160 support processor

1. An information processing system comprising:
a first state change processor configured to change an association state of a specific virtual reality medium usable in a virtual space from a state of being associated with a first user to a state of being associated with a second user;
a history memory configured to store a change history of the association state related to the specific virtual reality medium;
a user information memory configured to store user information related to a plurality of users including the first and second users; and
an association processor configured to generate or update predetermined information related to the specific virtual reality medium, based on the user information related to at least one target user among a plurality of target users including (i) a past user associated with the specific virtual reality medium in the association state included in the change history and (ii) the second user associated with the specific virtual reality medium.

2. The information processing system according to claim 1, wherein
the predetermined information includes at least one of item value information indicating an item value of the specific virtual reality medium and item attribute information indicating an item attribute of the specific virtual reality medium.

3. The information processing system according to claim 2, wherein
the user information includes at least one of a current value and a past value of a predetermined parameter related to each user, and
the association processor generates or updates the predetermined information based on a value including at least one of the current value and the past value of the predetermined parameter related to the at least one target user.

4. The information processing system according to claim 3, wherein
the association processor generates or updates the predetermined information based on whether a predetermined condition is satisfied with respect to the at least one target user based on the value including at least one of the current value and the past value of the predetermined parameter related to the at least one target user.

5. The information processing system according to claim 4, wherein
the association processor generates or updates the predetermined information such that the item value or the item attribute of the specific virtual reality medium is different depending on whether or not the at least one target user satisfies the predetermined condition.

6. The information processing system according to claim 4, wherein
the association processor generates or updates the predetermined information based on the value including at least one of the current value and the past value of the predetermined parameter related to the at least one target user who satisfies the predetermined condition.

7. The information processing system according to claim 4, wherein
when the predetermined condition is satisfied, the association processor generates or updates the predetermined information (i) based on a number of changes in the association state or a period of time from a most recent association state in which the at least one target user who satisfies the predetermined condition was associated with the specific virtual reality medium to the current association state, or (ii) based on a total number of changes in the association state related to the specific virtual reality medium.

8. The information processing system according to claim 7, wherein
the association processor generates or updates the predetermined information in a manner that changes the item value or the item attribute of the specific virtual reality medium according to the number of changes or the period of time.

9. The information processing system according to claim 4, wherein
the association processor generates or updates the predetermined information (i) based on a duration of the association state in which the at least one target user who satisfies the predetermined condition is now associated or (ii) based on a duration of the association state in which the at least one target user who satisfies the predetermined condition was previously associated.

10. The information processing system according claim 5, wherein
the association processor generates or updates the predetermined information in a manner that is more favorable for the at least one target user (i) by associating a new item attribute with the specific virtual reality medium or (ii) by changing the item attribute associated with the specific virtual reality medium to another item attribute.

11. The information processing system according to claim 4, wherein
the predetermined parameter includes at least one of a current user attribute and a past user attribute related to each user, and
the predetermined condition includes a first predetermined condition that is satisfied when the current or past user attribute is or was the predetermined attribute, respectively.

12. The information processing system according to claim 4, wherein
the predetermined condition includes a second predetermined condition that is satisfied when the value including at least one of the current value and the past value of the predetermined parameter is a predetermined value or within a predetermined range.

13. The information processing system according to claim 12, wherein
the predetermined parameter includes (i) a parameter related to an award to be given with respect to an activity of each target user in the virtual space, and (ii) a parameter related to an evaluation from other users with respect to the activity of each target user in the virtual space.

14. The information processing system according to claim 2, further comprising
an effect processor configured to exert a predetermined effect on a first avatar related to the specific virtual reality medium, a second avatar in a vicinity of the first avatar, or an object in the vicinity of the first avatar, based on the item attribute information related to the specific virtual reality medium.

15. The information processing system according to claim 1, further comprising
a second state change processor configured to change the association state with each user of an electronic medium having a predetermined value from the state of being associated with the second user to the state of being associated with the first user when the association state related to the specific virtual reality medium is changed by the first state change processor from the state of being associated with the first user to the state of being associated with the second user.

16. The information processing system according to claim 1, wherein
the specific virtual reality medium includes at least one of (i) an item to be attached to an avatar and (ii) an item to be arranged in the virtual space.

17. The information processing system according to claim 1, wherein
the change history is stored for each specific virtual reality medium of a plurality of specific virtual reality media and is output to a terminal of each user.

18. The information processing system according to claim 1, wherein
the specific virtual reality medium is issued as a non-fungible token (NFT).

19. An information processing method that is executed by a computer, the method comprising:
changing an association state of a specific virtual reality medium usable in a virtual space from a state of being associated with a first user to a state of being associated with a second user;
storing a change history of the association state related to the specific virtual reality medium;
storing user information related to a plurality of users including the first and second users; and
generating or updating predetermined information related to the specific virtual reality medium, based on the user information related to at least one target user among a plurality of target users including (i) a past user associated with the specific virtual reality medium in the association state included in the change history and (ii) the second user associated with the specific virtual reality medium.

20. A non-transitory computer-readable medium storing thereon a program that causes a computer to execute:
changing an association state of a specific virtual reality medium usable in a virtual space from a state of being associated with a first user to a state of being associated with a second user;
storing a change history of the association state related to the specific virtual reality medium;
storing user information related to a plurality of users including the first and second users; and
generating or updating predetermined information related to the specific virtual reality medium, based on the user information related to at least one target user among a plurality of target users including (i) a past user associated with the specific virtual reality medium in the association state included in the change history and (ii) the second user associated with the specific virtual reality medium.
